(19) United States
(12) Patent Application Publication
(10) Pub. No.: US 2025/0179233 A1
(43) Pub. Date: Jun. 5, 2025

(54) PROCESS AND CATALYSTS FOR HYDROGEN MEDIATED ANIONIC COPOLYMERIZATION OF CONJUGATED DIENES AND LIQUID COPOLYMERS THEREOF

(71) Applicant: ALBEMARLE CORPORATION, Charlotte, NC (US)

(72) Inventor: William J. Layman, Baton Rouge, LA (US)

(73) Assignee: ALBEMARLE CORPORATION, Charlotte, NC (US)

(21) Appl. No.: 18/842,184

(22) PCT Filed: Mar. 1, 2023
(86) PCT No.: PCT/US2023/063416

§ 371 Date: Aug. 28, 2024

Related U.S. Application Data
(60) Provisional application No. 63/268,727, filed on Mar. 1, 2022.

(51) Int. Cl. C08F 236/08; C08F 2/06; C08F 4/48

(52) U.S. Cl. CPC C08F 236/08; C08F 2/06; C08F 4/48

(57) ABSTRACT

The disclosure relates to hydrogen mediated anionically copolymerized conjugated diene vinyl aromatic compositions, copolymers of isoprene and/or butadiene with styrene, and processes and compositions for preparing them.

### CROSS-REFERENCE TO RELATED APPLICATIONS

This international application, filed 28 Feb. 2023 under the Patent Cooperation Treaty, claims the benefit of U.S. Provisional Patent Application Ser. No. 63/268,727, filed 1 Mar. 2022, entitled “PROCESS AND CATALYSTS FOR HYDROGEN MEDIATED ANIONIC COPOLYMERIZATION OF CONJUGATED DIENES AND LIQUID COPOLYMERS THEREOF,” the entire contents and substance of which are hereby incorporated by reference as if fully set forth below.

### TECHNICAL FIELD

The various embodiments of the disclosure relate generally to processes and compositions for hydrogen mediated anionically copolymerized conjugated diene (CD) compositions, copolymers of isoprene and/or butadiene with styrenic monomers, and processes and compositions for preparing them. It is particularly useful for processes and catalysts compositions that form hydrogen mediated polyisoprene (HMPIP) as well as hydrogen mediated polybutadiene (HMPBD) as liquid random copolymer distributions with polystyrene. The processes can be used to form hydrogen mediated random copolymers of styrene and butadiene and styrene and isoprene among other copolymers of styrene and other conjugated dienes. More generally the process and catalyst can be used to form random copolymers of vinylaromatic (VA) monomers with conjugated diene (CD) monomers (CD-VA or VA-CD copolymers). The lithium alkoxide complexed saline hydride (LOXSH) catalyst disclosed herein can provide control of both the regioselectivity and stereoselectivity during the copolymerization process to form a variety of hydrogen mediated poly-conjugated diene (HMPCD) copolymers with VA monomers particularly with styrenic monomers with excellent control of the degree of polymerization and co-monomer contents. The hydrogen mediated polyconjugated dienes copolymers with styrene (HMPCD-CoPS) compositions include HMPIP-CoPS and HMPBD-CoPS product distributions.

### BACKGROUND

Normally liquid butadiene-styrene random copolymers having both high vinyl-1,2 contents (about 70 wt. % of the butadiene portion) and low vinyl-1,2 contents (about 30 wt. % of the butadiene portion) are items of commerce with a wide variety of applications, vide infra. The high vinyl-1,2 compositions comprise 20 wt. % to 35 wt. % styrene or greater, have number average molecular weight between 4500 and 5300 Daltons, glass transition temperatures (T_{g}) in the range of −38° C. to −15° C. and viscosity greater than 40,000 cps (45° C. Brookfield). The low vinyl-1,2 content compositions typically comprise 28 wt. % styrene, have number average molecular weights (Mₙ) of 3200 to 8600 Daltons, glass transition temperatures in the range of −65° C. to −57° C. and viscosities of 17,500 cP to 75,000 cP (25° C. Brookfield). These butadiene-styrene copolymer compositions are made by anionic polymerization with sodium (Hsieh and Quirk Anionic Polymerization Principles and Practical Applications p. 616). Anionic polymerization with sodium requires stoichiometric levels of sodium and, though lower molecular weight compositions can be made, the cost escalates considerably with reduced molecular weights. There is a need for economically produced liquid butadiene-styrene copolymers of controlled low molecular weight, having reduced glass transition temperatures and much lower viscosities than is currently available. Such compositions should be made with highly efficient low-cost catalyst and catalytic processes with a high degree of control: I) of molecular weight distribution; II) of butadiene microstructure (high, low and intermediate vinyl-1,2 BD content); and III) of styrene content.

Polymerization of dienes generally produces an olefinic bond within each polymerized unit, but the olefinic bond can be one of several microstructural motifs, including microstructures with a cis-1,4-bond, a trans-1,4 bond, or a vinyl-1,2 pendant to the polymer. (See, for example, FIG. 1.) The polymer microstructure and polymer chain length distribution of the polymerized conjugated diene can generate products with a range of characteristics, including glass transition temperature (T_{g}), polymer viscosity, molecular weight, polydispersity, and asymmetry. The ability to selectively prepare low molecular weight poly(conjugated dienes) copolymers with styrene, while controlling viscosity and polymer microstructure, would give access to a new range of conjugated diene-styrene copolymer products. A less desirable microstructure motif formed in high vinyl polybutadiene compositions is the vinylcyclopentane (VCP) repeating unit. This microstructure is undesired for three reasons: 1) it reduces the number of double bonds available for derivatization; 2) it increases the glass transition temperature; and 3) it deleteriously increases viscosity—essentially exponentially relative to compositions number average molecular weight or Mₙ. This motifis known to form under anionic polymerizations conditions wherein the penultimate vinyl-1,2 butadiene repeating unit of a living polybutadiene chain undergoes a cyclization reaction with the anionic lithium(polybutadienyl) anion end group. For the purpose of determining total vinyl content one VCP repeating unit is regarded to have arisen from two sequential vinyl-1,2 motifs.

Generally speaking high vinyl-1,2 low molecular weight polybutadiene compositions are formed under chain transfer conditions wherein an aromatic hydrocarbon having one or more methyl groups (e.g. toluene) is the chain transfer agent. Effective chain transfer generally occurs when the chain transfer polymerization is conducted at higher temperatures (>70° C.) and/or higher ratios of a polytertiaryamine promotor (e.g. TMEDA) to lithium (TMEDA:Li is in the range of 1.5:1 to 8:1). Thus in order to achieve the desired level of chain transfer—to make low molecular weight compositions—higher temperatures and higher promotor:Li ratios can be required. However higher temperature and/or higher amine to lithium ratios leads to ever increasing levels of incorporation of the VCP microstructure of the product compositions' polymer chains. Consequently low molecular weight compositions exhibit increased T_{g} and viscosity at the otherwise desired reduced Mₙ.

According to the technical data sheet Ricon® 100 available from Cray Valley a brand of Total is a low molecular weight, liquid copolymer of butadiene (80 wt. %) and styrene (20 wt. %) with 70 wt. % 1,2-content of the butadiene portion. Ricon 100 has an Mₙ of 4500 Daltons, a T_{g} of −15° C. and a viscosity at 45° C. of 40,000 cps. The suggested applications for this resin include coatings, electronics laminates, tire tread, encapsulants, rubber and flexographic printing plates. Similarly Ricon® 257 is a low molecular weight, copolymer of butadiene (65 wt. %) and styrene (35 wt. %) that is sold as a formulation dissolved in toluene. Ricon 257 has a 70 wt. % 1,2-content of the butadiene portion, an Mₙ of 5300 Daltons, a T_{g} of −38° C. and a solution viscosity at 25° C. of 900 cps. The suggested applications for this resin formulation include electronics, copper clad laminates, composites, and elastomers. Ricon® 181 is a low vinyl butadiene-styrene liquid copolymer comprising butadiene (72 wt. %) and styrene (28 wt. %) and having a vinyl-1,2 content of 30 wt. % of the butadiene portion. Ricon 181 has an Mₙ of 3200 Daltons, a T_{g} of −65° C. and a viscosity at 25° C. of 17,500 cps. Ricon® 184 is a low vinyl butadiene-styrene liquid copolymer comprising butadiene (72 wt. %) and styrene (28 wt. %) and having a vinyl-1,2 content of 30 wt. % of the butadiene portion. Ricon 184 has an Mₙ of 8600 Daltons, a T_{g} of −57° C. and a viscosity at 25° C. of 75,000 cps. Both of these low vinyl grades are suggested for uses in applications that include coatings, electronics, laminates encapsulants, rubber and flexographic printing plates.

High vinyl-1,2 compositions can be highly desirable because they are very reactive and are easier to crosslink. However, such high vinyl-1,2 compositions when formed by organic chain transfer suffer from relatively high viscosity at low molecular weights and lower molecular weights increase the volatile content. Such compositions incorporate at least one organic chain transfer agent per polymer chain of the distribution.

Accordingly, polybutadiene telomers (telomerization with toluene) can provide low viscosity (Brookfield 25° C. of 300, 700 and 8500 cP) of low molecular weight (900, 1300, and 2600 Daltons respectively) liquid butyl rubbers wherein the vinyl content is less than about 50%. Such compositions are produced at lower temperatures and require the addition of a potassium or sodium metal alkoxide (e.g. potassium or sodium tert-butoxide). It is also understood in the art that telomerization catalyst formed from butyllithium and TMEDA will provide BR telomers having 40-50% vinyl microstructure and 15-20% vinylcyclopentane microstructure. Such a BR telomer distribution having a Mₙ of 1000 Daltons have a Brookfield viscosity at 25° C. of 4000 cP. Likewise, a BR telomer distribution having a Mₙ of 1800 Daltons will have a Brookfield viscosity at 35° C. of 45,000 cP (in this connection see Luxton, A. R., Rubber Chem. & Tech., 1981, 54, 591).

High vinyl content can be desired because the vinyl-1,2 motif reacts faster in some chemistries than the 1,4-olefins. Moreover, low viscosity, low T_{g} and low molecular weights can be desirable physical properties and characteristics. Incorporation of styrene as a comonomer with butadiene (or isoprene for that matter) will increase the viscosity of the composition. Low styrene content copolymer compositions can suffer from the formation of high VCP contents and consequently exhibit higher viscosity as well as increased glass transition temperatures. It would be desirable to have copolymerization process chemistry that can provide butadiene-styrene copolymer compositions:
1. of modest to moderately high styrene content (10-40 wt. %) with high vinyl-1,2 content (>70% total vinyl contents), low VCP contents that exhibit reduced viscosity and reduced glass transition temperatures;
2. of higher styrene content (25-40 wt. %) with moderately high vinyl-1,2 content (from about 40 wt. % to about 70 wt % total vinyl contents), low VCP contents that exhibit low viscosity and low glass transition temperatures;
3. of higher styrene content (25-40 wt. %) with low high vinyl-1,2 content (from about 30 wt. % to about 40 wt % total vinyl contents), low VCP contents that exhibit very low viscosity and very low glass transition temperatures.
   These such desired compositions—producible by this disclosure—should also exhibit iodine values/numbers that approach the theoretical value for the copolymers when adjusted for styrene contents. This theoretical I₂N for butadiene styrene copolymers is given by the following equation (1):

$${I}_{2} N = ( \frac{456 g {I}_{2}}{100 g copolymer} ) \times {X}_{BD} \qquad ( 1 )$$

Wherein X_{BD} is the weight fraction of butadiene repeating units. Correcting the equation above for VCP content provides the equation (2) below wherein X_{VCP} is the weight fraction of the VCP content of the total butadiene content. The VCP structural motif only provides one double bond per two butadiene units.

$${I}_{2} N = ( \frac{456 g {I}_{2}}{100 g copolymer} ) \times {X}_{BD} \times ( 1 - {X}_{VCP} / 2 ) \qquad ( 2 )$$

Accordingly it is desirable for that a butadiene-styrene copolymer having a 20 wt. % styrene content have an I₂N equal to ≈80% of 456 and thus have an iodine value of in the range of about 350 to about 365 g I₂/100 g copolymer.

Hence a need still exists for an industrially efficient and cost-effective process technology that can provide new liquid butadiene-styrene as well as isoprene-styrene copolymer compositions of modestly high (greater than 45 wt %) to high (as high as about 80 wt %) vinyl-1,2 BD content or combined vinyl-3,4 IP and vinyl-1,2 IP content (as determined by proton NMR analyses). For the butadiene-styrene copolymers it is particularly desirable to maintain a high vinyl-1,2-BD to VCP ratio and thus provide liquid polybutadiene compositions of both increased reactivity (high iodine number) and low viscosity. Moreover, the low molecular chains should be comprised solely of the polymerizable comonomers, styrene and the conjugated diene (i.e. little to no organic chain transfer agent incorporation).

Through the process chemistry of this disclosure the entire range of relative comonomer content copolymer compositions from less than 100% to greater than 0% VA monomer content can be produced. And to be clear, likewise the range from more than 0% to less than 100% CD monomer content can be produced. It should be noted that it is desirable to have at least one VA monomer per discrete copolymer chain. Thus desirably the mole % of a VA monomer should be wherein the product [x_{VA}*DPₙ]>1.0. Wherein x_{VA} is the mole fraction of the VA monomer of the copolymer having the number average degree of polymerization DPₙ. For example, a copolymer having DPₙ=18 it is desirable that the weight fraction VA is about 11.1% and the x_{VA}=0.0555%. Thus at lower DPₙ higher VA monomer contents are desirable and should be easily and precisely producible. Accordingly for compositions wherein [x_{VA}*DPₙ]<1.0, it becomes a mathematical certainty that the product composition is a mixture of homopolymer and copolymer. The analogous argument regarding CD monomer contents for high VA copolymers is easily made. Such mixtures of homopolymer and co-polymer are deemed to be new compositions producible of and a part of this disclosure. The entire span of these properties and characteristics of liquid butadiene-styrene copolymer compositions cited above can be easily manufactured by the processes and catalyst of this disclosure via very tunable inexpensive catalyst systems and with chain transfer affected with a very inexpensive chain transfer agent—hydrogen.

### BRIEF SUMMARY

The various embodiments of the disclosure relate generally to processes, catalysts, compositions, and polymer products for liquid conjugated diene-styrene copolymer products. An embodiment of the disclosure can be a process for copolymerizing styrenic and conjugated dienes monomers in a hydrocarbon reaction medium. The process can include the chemical addition of a lithium alkoxide complexed saline hydride LOXSH reagent to a conjugated diene or to the styrenic monomer to form a polymer initiating species and polymerizing at least a portion of the anionically polymerizable hydrocarbon monomer. Another embodiment of the disclosure can be a process for hydrogen mediated copolymerization of styrenic monomers with conjugated diene monomers in a hydrocarbon reaction medium, where the process can similarly include the chemical addition of a lithium alkoxide complexed saline hydride (LOXSH) reagent to a either the styrenic monomer or the conjugated diene monomer to form a polymerization initiator and polymerizing the comonomers in the presence of hydrogen or hydride mediation (e.g. organic silicon hydrides). In each process, the LOXSH reagent comprises one or more σ−μ polar modifiers. The process can also be conducted in the presence of molecular hydrogen and can include co-feeding at least two gaseous and/or volatile compounds and at least one liquid styrenic comonomer to the reaction medium, wherein the at least two gaseous and/or volatile compounds include the hydrogen and the conjugated diene.

An embodiment of the disclosure can be the copolymerization processes above where the conjugated diene comprises isoprene and/or butadiene. The process can include butadiene, isoprene, 2-methyl-1,3-pentadienes (E and Z isomers); piperylene; 2,3-dimethylbutadiene; 2-phenyl-1,3-butadiene; cyclohexadiene; β-myrcene; β-farnesene; and hexatriene. The random copolymerization process further entails copolymerizing the conjugated diene with vinylaromatic (VA) hydrocarbon monomers which can include styrene, methyl-styrene(s), higher C2-C10 alkylstyrenes, vinyl-naphthalene, alpha-methylstyrene(s) and the like. Other vinylaromatic monomers useful in the practice of this disclosure can include 4-vinylanisole as well as 6-methoxy-1-vinylnaphthalene, o,p,m N,N-dimethylaminostyrene(s) as well as 6-N,N-dimethylamino-1-vinylnaphthalenes and similar compositions as long as the vinylaromatic monomer does not possess functionalities that will react with the catalyst which would include halogens, carbonyl groups, nitriles and other functional groups recognized as reactive to hydrides by one of ordinary skill in the art. The vinylaromatic monomer should also not have a proton having a pKₐ less than 4.3 units below that of toluene in the reaction medium. It should be understood that the use of divinylbenzene as well as methylstyrene comonomers can lead to HEMPCD-CoPS copolymer compositions having branched polymer architecture. Such branched molecular architecture is an embodiment of this disclosure.

In an embodiment of the disclosure, the one or more σ−μ polar modifiers can be selected from one or more of the Structures I-IX:

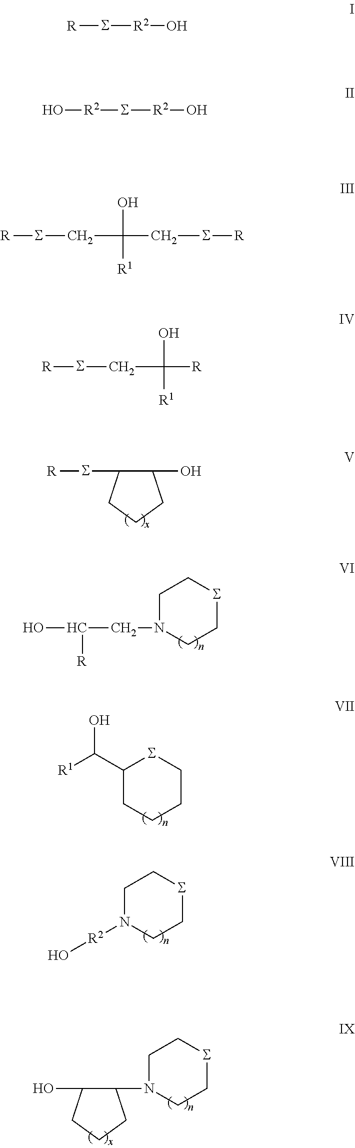

R can be independently an alkyl group which may also be further substituted by other tertiary amines or ethers. R¹ can be independently a hydrogen atom or an alkyl group which may also be further substituted by other tertiary amines or ethers. R² can be —(CH₂)_{y}—, wherein y=2, 3, or 4. Σ can include: i) O or NR for I, II, III, IV, and V; ii) and O or NR or CH₂ for VI, VII, VIII and IX. The term n can be independently a whole number equal to or greater than 0, and the term x can be independently a whole number equal to or greater than 1. It is to be understood and appreciated that for structures V-IX above and below, when n is equal to zero that means that the carbon atom does not exist and that a single covalent bond exists between the two adjoining atoms of the structure. It is to be understood and appreciated that the structures I-IX can include very complex chiral structures such as the ones set forth in “Chart 1” of Parsons, Jr. R. L., et al., J. Am. Chem. Soc. 2001, 123, 9135-9143. Such chiral σ−μ polar modifiers as presented by Parsons et al. and the like are incorporated here by reference.

In an embodiment of the disclosure, the reaction medium for the process can be a hydrocarbon solvent with a pKₐ greater than that of H₂. In an embodiment of the disclosure, the reaction medium can include molecular hydrogen and the partial pressure of molecular hydrogen can be maintained either by a set hydrogen regulator or autogenously by a set relative hydrogen feed rate at partial pressures between about 0.01 Bar to about 19.0 Bar. In an embodiment of the disclosure, the process can include a temperature that can be maintained in the range of about 20° C. to about 130° C. In an embodiment of the disclosure, the process can include a relative feed rate of total monomer to hydrogen of from about 5 mole to about 50 mole (CD+styrenic monomer)/mole H₂. In an embodiment of the disclosure, the molar ratio of the total charge of monomer to soluble saline hydride catalyst can be about 10:1 to about 1500:1. In an embodiment of the disclosure, the saline hydride catalyst can be one or more of 1) LOXLiH reagent; 2) LOXNaH reagent; 3) LOXMgH₂; and/or 4) LOXKH reagent.

In an embodiment of the disclosure, the aminoalcohol (AA) σ−μ polar modifier can be one more of N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 1-methyl-2-piperidinemethanol; 1-methyl-2-pyrrolidinemethanol; diethylaminoethanol; N-methyl-diethanolamine; 3-dimethylamino-1-propanol, 1,3-bis(dimethylamino)-2-propanol; and 2-{[2-dimethylamino)ethyl]methylamino}ethanol;

In an embodiment of the disclosure, the amino-ether alcohol (AEA) σ−μ polar modifier can be one more of 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 2-[2-(dimethylamino)ethoxy]ethanol, 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol.

In an embodiment of the disclosure, the process can include one or more of the σ−μ polar modifiers described above, and can further include one or more of ether-alcohol (EA) σ−μ polar modifier 2-methoxyethanol, 1-methoxypropan-2-ol, 1-methoxybutan-2-ol, 2-methoxycyclohexan-1-ol, tetrahydrofurfuryl alcohol, tetrahydropyran-2-methanol, diethylene glycol monomethyl ether.

In an embodiment of the disclosure, the LOXSH catalyst can include between about 50 mole % to less than 100 mole % of a tertiary amino-alcohol or a tertiary amino-ether-alcohol σ−μ polar modifier and from about 50 mole % to greater than 0 mole % of an ether-alcohol σ−μ polar modifier. The tertiary amino-alcohol σ−μ polar modifier selected from one or more of N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol. The ether-alcohol σ−μ polar modifier can be selected from one or more of 2-methoxyethanol, I-methoxypropan-2-ol, I-methoxybutan-2-ol, trans-2-methoxycyclohexan-1-ol, 2-methoxy-1-phenylethanol, tetrahydrofurfuryl alcohol, or tetrahydropyran-2-methanol, or diethylene glycol monomethyl ether.

In an embodiment, the process can further include either or both of a μ type polar modifier (e.g. sodium mentholate and the like) and/or a σ type polar modifier (e.g. THF, TMEDA, and the like).

An embodiment of the disclosure can include a LOXSH catalyst or reagent composition, where the composition can be selective for 1,4-CD monomer microstructure enchainment. The composition can comprise 1) at least one tertiary amino alcohol σ−μ polar modifiers having a 2° or a 3° alcohol functional group; 2) an organolithium compound; and 3) optionally elemental hydrogen and/or an organo silicon hydride. The polar modifier can be selected from at least one of the structures:

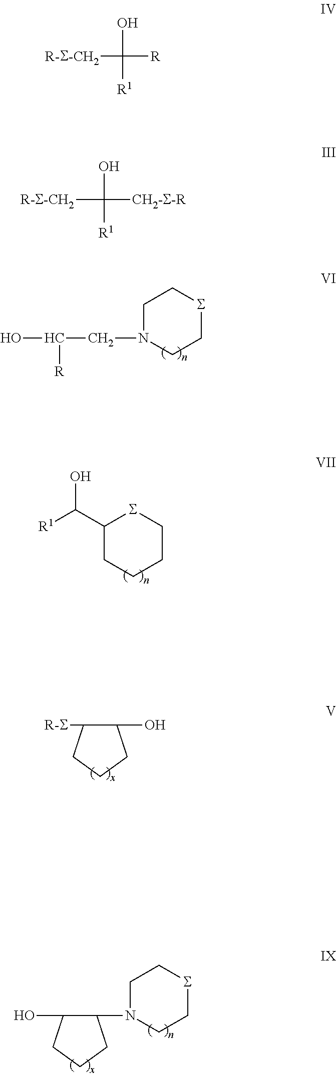

wherein R is independently an alkyl group which may also be further substituted by other tertiary amines or ethers, R¹ is independently a hydrogen atom or an alkyl group which may also be further substituted by other tertiary amines or ethers, Σ can include: i) O or NR for III, IV, and V; ii) and for VI, VII, and IX can include O or NR or CH₂; n is independently a whole number equal to or greater than 0, and x is independently a whole number equal to or greater than 1. The σ−μ polar modifier can include one or more of 1-dimethylamino-2-propanol, 1-piperidino-2-propanol, 1-pyrrolidinylpropan-2-ol, 1-morpholino-2-propanol, 1-(4-Methyl-1-piperazinyl)-2-propanol, 1-dimethylamino-2-butanol 1-piperidino-2-butanol, 1-pyrrolidinylbutan-2-ol, 1-morpholino-2-butanol, 1-(4-methyl-1-piperazinyl)-2-butanol, 2-dimethylaminocyclohexan-1-ol, 2-piperidinocyclohexan-1-ol, 2-pyrolidinocyclohexanol, 2-(4-methyl-1-piperazinyl)-cyclohexanol, 2-morpholinocyclohexan-1-ol, 2-(dimethylamino)-1-phenylethanol; 1-phenyl-2-piperidin-1-ylethanol; 1-phenyl-2-(1-pyrrolidinyl)-1-ethanol; 2-(4-methylpiperazino)-1-phenylethan-1-ol; 2-morpholino-1-phenyl-1-ethanol, 1,3-bis(dimethylamino)-2-propanol with optional addition of one or more of 2-methoxyethanol, 1-methoxypropan-2-ol, 1-methoxybutan-2-ol, 2-methoxycyclohexan-1-ol, 2-methoxy-1-phenylethanol, tetrahydrofurfuryl alcohol, or tetrahydropyran-2-methanol; or diethylene glycol monomethyl ether.

An embodiment of the disclosure can include a LOXSH catalyst or reagent composition, wherein the composition can be selective for 3,4-CD and/or vinyl 1,2-CD monomer microstructure enchainment. The composition can comprise a) at least one tertiary amino alcohol or tertiary ether alcohol σ−μ polar modifiers; b) at least one separate ether-alcohol σ−μ polar modifiers; c) an organo lithium compound; and d) optionally elemental hydrogen and/or an organo silicon hydride. The σ−μ polar modifiers can be selected from at least two of the structures:

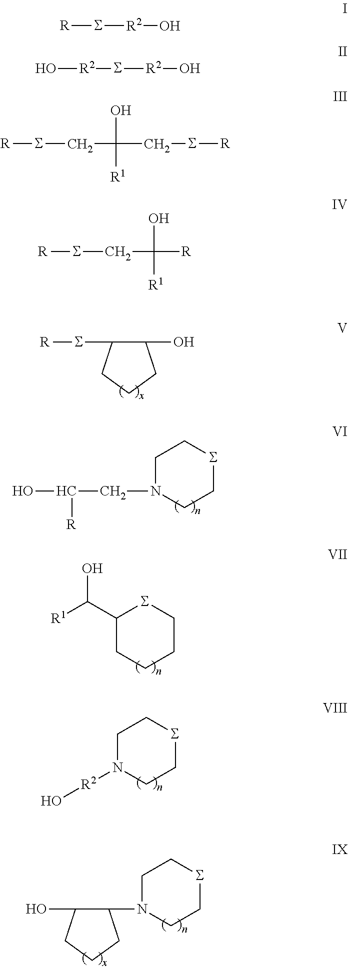

wherein R is independently an alkyl group which may also be further substituted by other tertiary amines or ethers, R¹ is independently a hydrogen atom or an alkyl group which may also be further substituted by other tertiary amines or ethers, R² is —(CH₂)_{y}—, wherein y=2, 3, or 4, Σ can include: i) O or NR for I, II, III, IV, and V; ii) and for VI, VII, VIII and IX can include O or NR or CH₂; n is independently a whole number equal to or greater than 0, and x is independently a whole number equal to or greater than 1. The σ−μ polar modifiers of the reagent comprises between about 50 mole % to less than 100 mole % of a tertiary amino-alcohol or a tertiary amino-ether-alcohol σ−μ polar modifier selected from one or more of: N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol. The ether-alcohol σ−μ polar modifier can be selected from one or more 2-methoxyethanol, 1-methoxypropan-2-ol, 1-methoxybutan-2-ol, trans-2-methoxycyclohexan-1-ol, 2-methoxy-1-phenylethanol, tetrahydrofurfuryl alcohol, or tetrahydropyran-2-methanol, or diethylene glycol monomethyl ether. In an embodiment, the ratio of total amino-alcohol (AA) and/or amino-ether-alcohol (AEA) to the total separate ether-alcohol (EE) σ−μ polar modifier ([AA+AEA]:EA) is in the range of about 9:1 to 1:1 and preferably in the range of about 4:1 to about 2:1

An embodiment of the disclosure can include hydrogen mediated anionic VA-CD copolymer distribution composition, that can be characterized as having 1) number average degree of polymerization DPₙ in the range of about 7 to about 50 repeating units; 2) a Brookfield viscosity (45° C.) in the range of about 10 to about 300,000 cP; 3) 1,4-CD microstructure content in the range of 20% to about 80%; and 4) glass transition temperature T_{g} in the range of about −110° C. to about 5° C.

### BRIEF DESCRIPTION OF THE DRAWINGS

FIG. 1 illustrates standard polymer microstructural units for the poly-conjugated dienes, including microstructures of the conjugated diene-styrene copolymer compositions in accordance with exemplary embodiments of the disclosure.

FIG. 2 illustrates an XY-Scatter Data of Viscosity (Y-axis, Brookfield, 45° C., cP) vs. Mₙ (X-axis, Daltons) for HMPBD homopolymers disclosed in a commonly owned copending application (WO2022051376A1) providing the floor for the viscosity values vs. molecular weight for the butadiene-styrene copolymers of this disclosure.

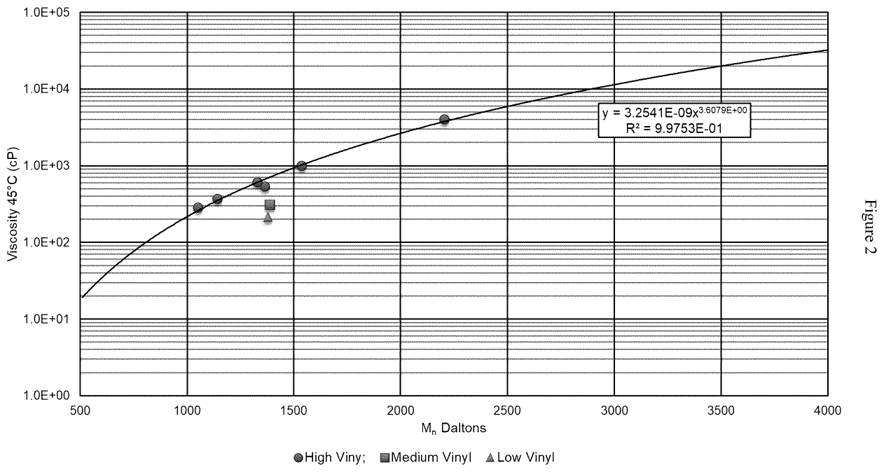

FIG. 3 illustrates XY-Scatter Data of Viscosity (Y-axis, Brookfield, 45° C., cP) vs. Mₙ (X-axis, Daltons) for high vinyl 1,2-BD butadiene-styrene copolymers comprising a range of styrene contents in accordance with exemplary embodiments of the disclosure.

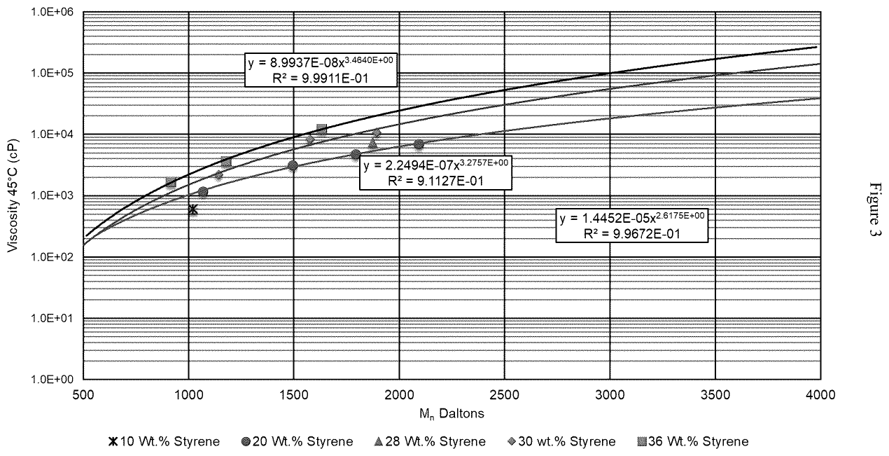

FIG. 4 illustrates XY-Scatter Data of Viscosity (Y-axis, Brookfield, 45° C., cP) vs. Mₙ (X-axis, Daltons) comprising a range of vinyl 1,2-BD contents for butadiene-styrene copolymers comprising 28 wt. % styrene in accordance with exemplary embodiments of the disclosure.

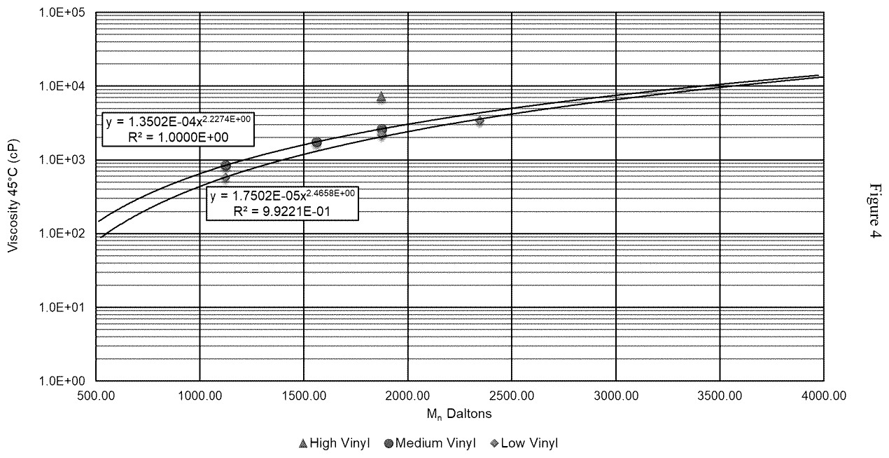

FIG. 5 illustrates XY-Scatter Data of 1/T_{g} (y axis K⁻¹) vs. 1/Mₙ (X-axis, Daltons⁻¹) for high vinyl 1,2-BD butadiene-styrene copolymers comprising a range of styrene contents in accordance with exemplary embodiments of the disclosure.

FIG. 6 illustrates XY-Scatter Data of 1/T_{g} (y axis K⁻¹) vs. 1/Mₙ (X-axis, Daltons⁻¹) comprising a range of vinyl 1,2-BD contents for butadiene-styrene copolymers comprising 28 wt. % styrene in accordance with exemplary embodiments of the disclosure.

FIG. 7 illustrates a calibration relating the weighted average DPₙ of the butadiene-styrene copolymer compositions—related separately, segregated based upon high or lower vinyl contents—(after stripping solvent and the low molecular weight butadiene-styrene copolymer oligomers) as a function of the ratio of total butadiene and styrene to total hydrogen, demonstrating that any DPₙ over the range of about 5 to about 45 repeating comonomer units can be produced by design, in accordance with exemplary embodiments of the disclosure.

FIG. 8 illustrates a calibration relating the weighted average Mₙ of the butadiene-styrene copolymer compositions—related separately, segregated based upon high or lower vinyl contents—(after stripping solvent and the low molecular weight butadiene-styrene copolymer oligomers) as a function of the calculated weighted Mₙ derived from the ratio of total butadiene and styrene to total hydrogen, demonstrating that any Mₙ over the range of about 500 to about 4000 Daltons can be produced by design, in accordance with exemplary embodiments of the disclosure.

FIG. 9 illustrates structure activity relationship of preferred tertiary amino alcohol σ−μ polar modifiers used in forming the catalyst, in accordance with exemplary embodiments of the disclosure.

FIG. 10 illustrates the reaction pressure and temperature profiles for Examples 7 and 8 demonstrating that the autogenous pressure of each Example differed with the primary cause attributed to the titanium (IV) tert-butoxide activator of Ex. 8.

FIG. 11 illustrates the reaction pressure and temperature profiles for Example 21 wherein vinyl-1,2 selective 2-piperidinoethanol σ−μ polar modifier was used to form a high vinyl 1,2-BD microstructure butadiene-styrene copolymer (29.6 wt. % styrene) product composition having Mₙ of 1849 Daltons.

FIG. 12 illustrates the reaction pressure and temperature profiles for Examples 28-30 wherein the 1,4-BD selective LOXLiH catalyst formed from 1-piperidino-2-butanol as the σ−μ polar modifier where low vinyl butadiene-styrene copolymer distribution compositions (28 wt. % styrene) having Mₙ of 2004, 1318 and 2265 Daltons respectively were formed, in accordance with exemplary embodiments of the disclosure. The comparison clearly illustrates how the autogenous pressure adjust to the ratio of total comonomer to hydrogen is coifed.

### DETAILED DESCRIPTION

Although preferred embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. The disclosure is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another embodiment includes from the one particular value and/or to the other particular value.

By “comprising” or “comprising” or “including” is meant that at least the named compound, element, particle, or method step is present in the composition or article or method, but does not exclude the presence of other compounds, materials, particles, method steps, even if the other such compounds, material, particles, method steps have the same function as what is named.

The term “and/or” means singular or a combination. For Example, “A and/or B” means “A” alone, “B” alone, or a combination of A and B.

The term “with or without” means singular or in combination. For Example, A with or without B means “A” alone or a combination of A and B.

It is also to be understood that the mention of one or more method or process steps does not preclude the presence of additional method steps or intervening method steps between those steps expressly identified. Similarly, it is also to be understood that the mention of one or more components in a device or system does not preclude the presence of additional components or intervening components between those components expressly identified.

The term “alkyl”, as used herein, unless otherwise indicated, includes saturated monovalent hydrocarbon radicals having straight or branched moieties. Examples of alkyl groups include, but are not limited to, methyl, ethyl, propyl, isopropyl, butyl, isobutyl, t-butyl, pentyl and hexyl.

The term “aryl”, as used herein, unless otherwise indicated, includes an organic radical derived from an aromatic hydrocarbon by removal of one hydrogen, such as phenyl, naphthyl, indenyl, and fluorenyl. “Aryl” encompasses fused ring groups wherein at least one ring is aromatic.

The term “aralkyl” as used herein indicates an “aryl-alkyl-” group. Non-limiting example of an aralkyl group is benzyl (C₆H₅CH₂—) and methylbenzyl (CH₃C₆H₄CH₂—).

The term “alkaryl” as used herein indicates an “alkyl-aryl-” group. Non-limiting examples of alkaryl are methylphenyl-, dimethylphenyl-, ethylphenyl-propylphenyl-, isopropylphenyl-, butylphenyl-, isobutylphenyl- and t-butylphenyl-.

The term “cycloalkyl”, as used herein, unless otherwise indicated, includes non-aromatic saturated cyclic alkyl moieties wherein alkyl is as defined above. Examples of cycloalkyl include, but are not limited to, cyclopropyl, cyclobutyl, cyclopentyl, cyclohexyl, and cycloheptyl.

The term “polymer”, as used herein, unless otherwise indicated, refers to the term “polymer” as defined in the context of the OECD definition of “polymer”, which is as follows:
“A chemical substance consisting of molecules characterized by the sequence of one or more types of monomer units and comprising a simple weight majority of molecules containing at least three monomer units which are covalently bound to at least one other monomer unit or other reactant and which consists of less than a simple weight majority of molecules of the same molecular weight. Such molecules must be distributed over a range of molecular weights wherein differences in the molecular weight are primarily attributable to differences in the number of monomer units.”
   Thus the OECD definition equally applies to the term copolymer. In this disclosure the term copolymer applies to any polymer comprising of two or more polymerizable monomer units. The exemplary embodiments of this disclosure are generally copolymers of two polymerizable comonomers i.e. isoprene and styrene as well as butadiene and styrene, the use of three or more comonomers is equally contemplated by this disclosure. It is pointed out that hydrogen is a monomer of this disclosure in that it is incorporated in the compositions of this disclosure. It is just not a polymerizable monomer.

Saline Hydrides (meaning ionic hydrides), as used herein, unless otherwise indicated, is defined by the presence of hydrogen as a negatively charged ion, H⁻, in combination with an alkali metal or alkaline earth metal said alkali metals include lithium, sodium, potassium, rubidium, and cesium; and said alkaline earth metals include magnesium and calcium.

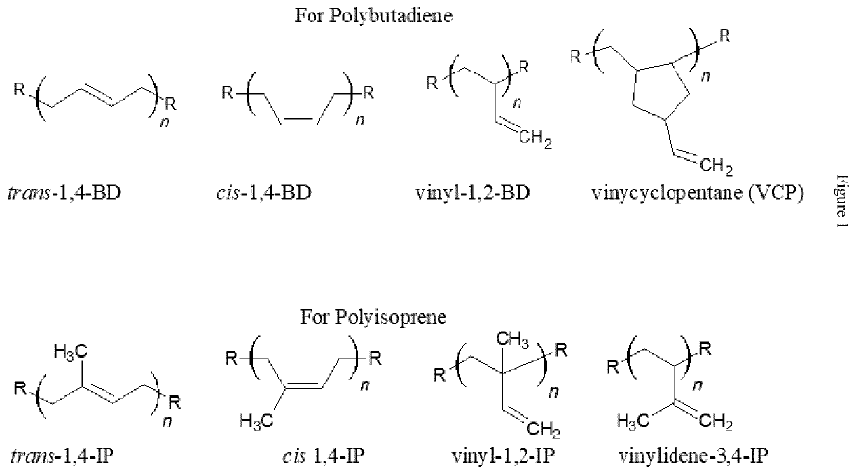

Polymer Microstructure and Molecular Architectures: Polymer microstructure as used here refers to a discrete polymer chain's (or chain length distribution of such chains) configuration in terms of its composition, sequence distribution, steric configuration, geometric and substitutional isomerism. An important microstructural feature of a polymer can be its architecture and shape, which relates to the way branch points lead to a deviation from a simple linear chain. For anionically polymerized polybutadiene and polyisoprene it is well understood that several constitutional microstructures can be formed (see FIG. 1).

Polar modifiers, as used herein, unless otherwise indicated, generally includes four different cases based on how they interact, moreover, complex with the cationic counterion(s) of the polymerization catalyst and/or initiator. The designations are σ, μ, σ+μ and σ−μ. A “a complex” denotes a polar modifier that is a Lewis base, e.g. THF, TMEDA. A “μ complex” denotes a polar modifier that is a Lewis acid e.g. sodium mentholate (SMT). A “σ+μ complex” denotes a mixture of polar modifiers contain both a Lewis base and an acid. A “σ−μ complex” denotes a polar modifier wherein both the Lewis base and acid are on the same ligand e.g. DMEA (DMAE). A comparison of the differing effects of 20 separate polar modifiers or combinations of polar modifiers (i.e. σ+μ) initiators on the vinyl content (ranging from 10% to 90% vinyl-1,2) of anionically polymerized butadiene is provided by Kozak and Matlengiewicz (Kozak, R., Matlengiewicz, M., “Influence of Polar Modifiers on Microstructure of Polybutadiene Obtained by Anionic Polymerization, Part 5: Comparison of μ, σ, σ+μ and σ−μ Complexes” Int. J Polym. Anal. Charact. 2017, 22, 51-61).

LOXSH, as used herein, unless otherwise indicated, can include a lithium amino-alkoxide complexed saline hydride, a lithium amine-ether-alkoxide complexed saline hydride, or a lithium ether-alkoxide complexed saline hydride formed from: (i) molecular hydrogen; (ii) an organolithium compound with or without an organomagnesium compound; (iii) optionally a polytertiaryamine compound (σ type polar modifier); (iv) a tertiary amino alcohol and/or a tertiary amino ether-alcohol and/or a ether-alcohol (σ−μ polar modifiers); (v) an optional solid alkali or alkaline earth metal hydride or an alkali metal or alkali metal alloy (vi) optionally an aromatic hydrocarbon having at least one C—H covalent bond pKₐ within the range of 2.75 pKₐ units above that of the pKₐ of toluene to −4.30 pKₐ units below the pKₐ of toluene; and (vii) a hydrocarbon solvent with a pKₐ greater than H₂; wherein the aromatic hydrocarbon and hydrocarbon solvent may be the same or different (see: Daasbjerg, K, Acta Chemica Scandinavica, 1995, 49, 878: “Estimation of the pKₐ for some Hydrocarbons and Aldehydes and Solvation Energies of the Corresponding Anions”).

LOXLiH is a term denoting the monometallic form of LOXSH where the catalyst/reagent is formed with lithium reagents as the only metal reagents. LOXNaH is a term denoting a bimetallic catalyst comprised of lithium and sodium wherein a portion of the active saline hydride is sodium hydride. LOXKH is a term denoting a bimetallic catalyst comprised of lithium and potassium wherein a portion of the active saline hydride is potassium hydride. LOXMgH₂ is a term denoting a bimetallic catalyst comprised of lithium and magnesium wherein a portion of the active saline hydride is a magnesium hydride.

A brief summary of parameters used to describe molecular weight distributions and the equations that define them are presented in Table I below. (A. Rudin, The Elements of Polymer Science and Engineering, Academic Press, Orlando, 1982, pp. 54-58). Molecular weight data are determined via GPC using polystyrene hydrogen mediated anionic polystyrene (HMAPS) oligomer distribution standards, or with commercial polystyrene standards with commercial polybutadiene standards as appropriate. See the Analytical Methods section of this disclosure for the procedures.

TABLE I

| Parameter | Equation |
|---|---|
| DPₙ, Number average degree of | DPₙ = (Mₙ − 2)/MWₐᵥₑ |
| polymerization | |
| MWₐᵥₑ denotes the weight average of the | MWₐᵥₑ = x_{VA}FW_{VA} + x_{CD}FW_{CD} |
| molecular weight of the monomer | x_{VA} and x_{CD} are the mole fractions of the VA |
| repeating units | and CD comonomers respectively and |
| | FW_{VA} and FW_{CD} are the formula weight of the |
| | VA and CD comonomers respectively |
| Mₙ, Number average molecular weight | Mₙ = (Σ Mᵢnᵢ) |
| M_{w}, Weight average molecular weight | M_{w} = [(Σ Mᵢ²nᵢ)/Mₙ] |
| M_{z}, z-Average molecular weight | M_{z} = (Σ Mᵢ³nᵢ)/ΣMᵢ²nᵢ |
| PD, Polydispersity Index (also PDI) | PD = (Σ Mᵢnᵢ)/[(Σ Mᵢ²nᵢ)/Mₙ] |
| Variance | V = (M_{w}Mₙ − Mₙ²) |
| Standard Deviation, σₙ | σₙ = √(M_{w}Mₙ − Mₙ²) |
| Skewness, ₙU₃ | ₙU₃ = M_{z}M_{w}Mₙ − 3Mₙ²M_{w} + 2Mₙ³ |
| Asymmetry, ₙα₃ | ₙα₃ = (M_{z}M_{w}Mₙ − 3Mₙ²M_{w} + 2Mₙ³)/σₙ³ |

The term “molecular hydrogen,” also referred to as “elemental hydrogen,” means H₂. H₂ typically means the common isotope ¹H₂ but can also include the isotopes of hydrogen ²H₂ or ³H₂ either as mixtures of the isotopes or enriched in a particular isotope whether in the gas state in the vapor space or dissolved in the condensed phase.

The term “polarizing complexing agent” ([PCA] in a chemical formula) is a general term for the neutral alcohol σ−μ polar modifiers (PM) used in forming the catalyst of this disclosure such as a tertiary amino alcohol, a tertiary amino ether-alcohol, or an ether-alcohol.

The disclosure entails a process for copolymerizing conjugated dienes with certain vinylaromatic monomers particularly styrenic hydrocarbon monomers. Copolymerization processes can be described in several different steps, including but not limited to initiation, polymerization, chain transfer, and termination. While it is convenient to refer to these steps as sequential and individual, a reaction mixture can be undergoing one or more of each of these steps at any point in time. However, in general, and without wishing to be bound by theory, a first step in a process can be an initiation step, where a catalyst composition, a polymerization reagent, a reactive initiator, or other species can be formed in a solution and then subsequently can react with the monomer. In describing an “initiating solution” or “initiation reagent” or other initiating specie, one of ordinary skill can recognize that the actual specie in solution may or may not be stoichiometrically the same as the components used to form it, but the reaction can still be described based on the components used to make that specie.

In this disclosure, an initiation step can entail the chemical addition of a saline hydride of a lithium alkoxide complexed saline hydride (LOXSH) reagent to the conjugated diene and/or the vinylaromatic co-monomer (hydrometallation reactions) and wherein the LOXSH reagent comprises one or more σ−μ polar modifiers. The disclosure can further include a process for hydrogen mediated copolymerization of conjugated dienes with vinylaromatic comonomers wherein an initiation step can entail the chemical addition of a saline hydride of a lithium alkoxide complexed saline hydride (LOXSH) reagent to the conjugated diene and or the vinylaromatic comonomer and wherein: 1) the LOXSH reagent comprises one or more σ−μ polar modifiers; and 2) the process can be conducted in the presence of elemental hydrogen. The initiation step can also include the chemical addition of the LOXSH reagent to ethylene, or any other anionically polymerizable hydrocarbon monomer (Hsieh and Quirk pp 96-99 inclusive of only hydrocarbon monomers).

The hydrogen mediated copolymerization of conjugated dienes with vinylaromatic comonomers of this disclosure can utilize σ−μ polar modifiers. These σ−μ polar modifiers can be selected from at least one of the structures:

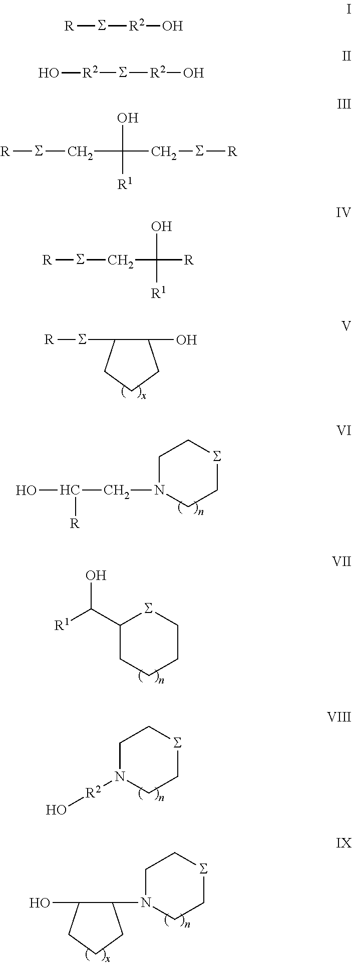

wherein R is independently an organic group which may also be further substituted by other tertiary amines or ethers, R¹ is independently a hydrogen atom or an organic group which may also be further substituted by other tertiary amines or ethers, R² is a —(CH₂)_{y}—group wherein y=2, 3, or 4, Σ can include: i) O or NR for I, II, III, IV, and V; ii) and for VI, VII, VIII and IX can include O or NR or CH₂; the index value n is independently a whole number equal to or greater than 0, the index value x is independently a whole number equal to or greater than 1. Preferably, R can be an alkyl or cycloalkyl group, more preferably an alkyl group, which can also be further substituted by other tertiary amines or ether. Similarly, R₁ can preferably be an alkyl or cycloalkyl group, more preferably an alkyl group, which can also be further substituted by other tertiary amines or ether.

The LOXSH catalysts, also referred to as LOXSH reagent, LOXSH reagent catalyst or LOXSH reagent composition, can be prepared as described in the commonly-owned WO2017176740, “Process and Hydrocarbon Soluble Saline Hydride Catalyst for Hydrogen Mediated Saline Hydride Initiated Anionic Chain Transfer Polymerization and Polymer Distribution Compositions Produced Therefrom,” the contents of which are incorporated by reference into this disclosure, as if fully set forth herein.

The processes of the disclosure can include the contemporaneous co-feeding of a vinylaromatic comonomer with at least two gaseous and/or volatile compounds to the reaction medium, wherein the two or more gaseous and/or volatile compounds comprise hydrogen and the low boiling conjugated diene(s). Low boiling conjugated dienes include conjugated dienes with a low vapor pressure, which can cause difficulties in maintaining a standard solution phase. A low boiling conjugated diene can have a boiling point of less than 200° C., or preferably less than 100° C., less than 80° C. or less than 70° C. Generally speaking a low boiling conjugated diene monomer is any such monomer with a boiling point about 15° C. to 20° C. below (or lower) than the desired hydrogen mediated anionic copolymerization reaction temperature such that running the process at a set hydrogen pressure is ineffective.

Preferred conjugated dienes (CD) include isoprene (IP and PIP for the polymer) and/or butadiene (BD or PBD for the polymer). The process also further includes styrene, styrenic or other vinylaromatic comonomers, which is randomly co-polymerized with the conjugated diene. Other anionically polymerizable conjugated diene monomers which can be used in this disclosure include 2-methyl-1,3-pentadienes (E and Z isomers); piperylene; 2,3-dimethylbutadiene; 2-phenyl-1,3-butadiene; cyclohexadiene; β-myrcene; and β-farnesene; or 2-methyl-1,3-pentadienes (E and Z isomers); piperylene; 2,3-dimethylbutadiene; 2-phenyl-1,3-butadiene; cyclohexadiene; or; piperylene and 2,3-dimethylbutadiene. It is conceivable that gemminal disubstituted dialkyl-cyclopentadiene could be employed in the processes of this disclosure. It should be noted that (Z)-1,3,5-hexatriene and hexatriene though not conjugated dienes—but conjugated trienes—may also be used in the present disclosure. The process can also include some amount of ethylene as an anionically polymerizable hydrocarbon monomer.

The processes of this disclosure can be conducted in reaction medium comprising a hydrocarbon solvent with a pKₐ greater than that of H₂. The process can be further characterized by a partial pressure of molecular hydrogen, where the partial pressure can be maintained at pressures between about 0.01 Bar to about 19.0 Bar. The temperature of the process can be maintained in the range of about 20° C. to about 130° C., about 30° C. to about 120° C., or about 40° C. to about 115° C. In the process, molar ratio of the total charge of monomer to soluble saline hydride catalyst initially formed can be about 10:1 to about 2000:1, preferably 20:1 to about 1500:1 and most preferred 50:1 to about 1200:1 and the saline hydride catalyst can be a one or more of: 1) LOXLiH reagent; 2) LOXNaH reagent; 3) LOXMgH₂ reagent; 4) LOXKH reagent 5) LOXRbH; and/or 6) LOXCsH.

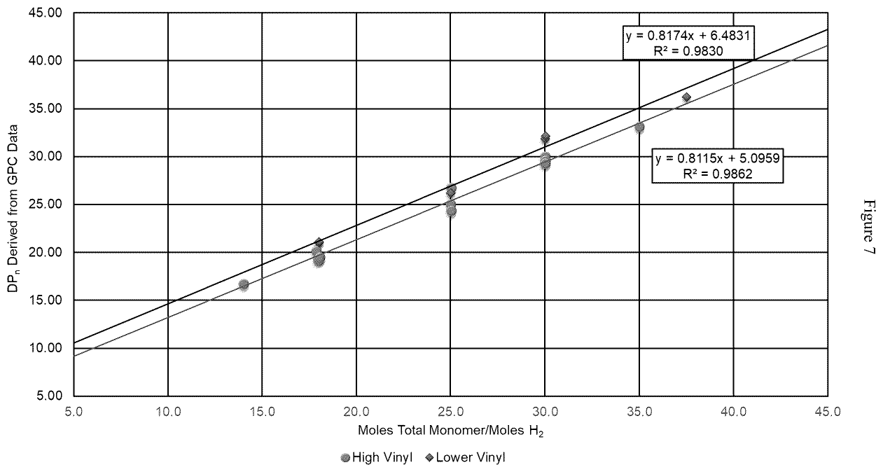

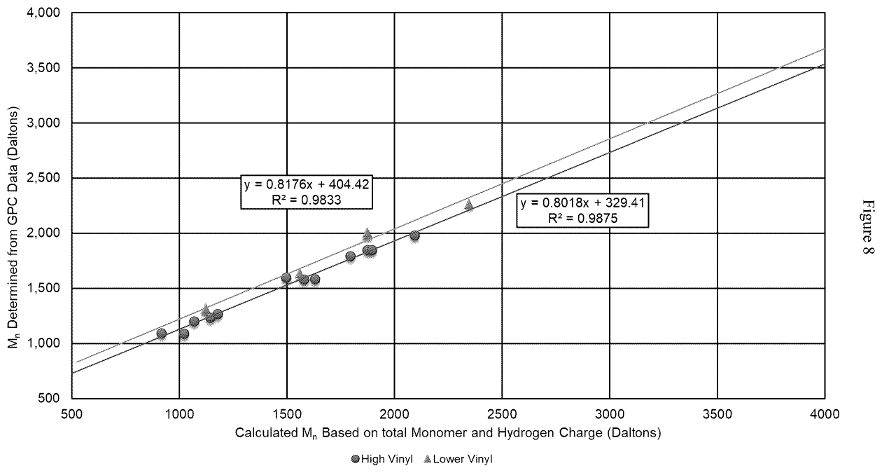

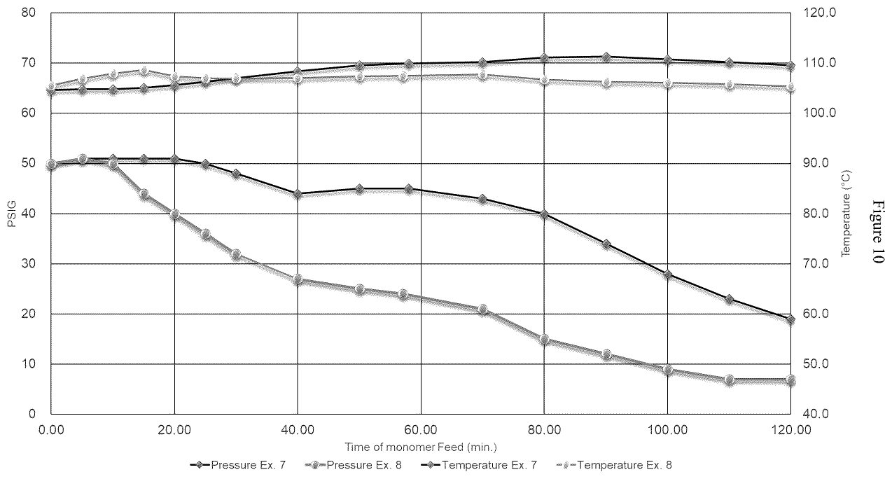

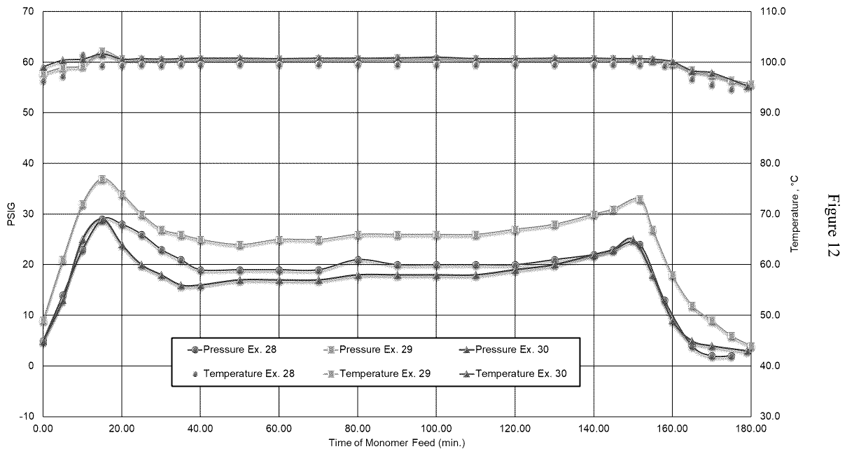

The processes of this disclosure can entail feeding a low boiling conjugated diene, including gaseous conjugated dienes such as 1,3-butadiene, isoprene, w/ BP<50° C., styrene (and/or a styrenic and/or other vinylaromatic comonomer) and hydrogen in a set molar ratio over the course of the entire feed—leaving the reactor pressure which can be a function of the partial pressure of any solvent vapor pressure. vinylaromatic comonomer, hydrogen and of the volatile conjugated diene—to adjust autogenously to achieve whatever activity of hydrogen and of conjugated diene in the condensed phase that is required to run the process efficiently and at a relative steady state pressure and temperature. In some embodiments the steady state pressure remains constant or near constant. In other embodiments wherein a large ratio of total monomer to catalyst charged is employed and especially wherein a more viscous product is formed, the reaction pressure can drift upwards over the course of the hydrogen mediated anionic copolymerization process. This mode of operation can be demonstrated by the drawings of FIGS. 10-12. The process comprises contemporaneous co-feeding low boiling conjugated dienes, (e.g. 1,3-butadiene) with a vinylaromatic monomer (e.g. styrene) with hydrogen in a pre-set molar ratio(s) to the copolymerization reaction mixture over a portion of, or preferably over the entire course of, the co-feed (preferably a contemporaneous tri-feed) wherein the reactor pressure adjusts autogenously to the consequent condensed phase activity of hydrogen and of the conjugated diene at a relative steady state pressure and temperature. The pre-set molar ratio can be varied as desired over the course of the process. Such a process provides precise and reproducible product distribution compositions wherein the number average molecular weight Mₙ can be proportional to the total of the butadiene and the styrene fed divided by the moles of hydrogen consumed, which is demonstrated by the graphs in FIGS. 7 and 8 of the data derived from the exemplary embodiments of the disclosure as presented in the Examples. A DPₙ and hence the number average molecular weight can be selected by adjusting the instantaneous relative feed ratio of total monomer to hydrogen to the reaction medium. The exact feed rate does not matter for the DPₙ; instead the relative feed rates matter when determining the desired DPₙ. The weighted average of the charged monomers in terms of mole fractions (x) determines the weighted average of FWₐᵥₑ of the monomers and hence it's multiplicative product with the DPₙ provides the desired Mₙ. The exact feed rate (in terms of total monomer per unit time relative to catalyst charge) can help shape the distribution (broaden or make less broad as well affect the asymmetry) as well as have an effect on the product microstructure particularly for liquid polybutadiene copolymer compositions. Accordingly, the processes of this disclosure can provide relatively narrow molecular weight distributions, MWD, with polydispersity in the range of about 1.6 to about 2.5 preferably in the range of 1.6 to about 2.2 and of low asymmetry in the range of 2.0 to about 3.4 preferably in the range of 2.0 to 2.7. The autogenously generated reaction pressure can be the result or the product of some combination of the following: a) the relative feed rate of hydrogen to total monomer; b) the feed rate of reactants relative to catalyst concentration; c) the reaction temperature; d) the activity of a particular LOXSH catalyst; and e) the vapor pressure of the reaction medium or solvent(s). Generally speaking LOXLiH and LOXNaH catalyst compositions that tend to form high vinyl-1,2 content compositions tend to also be the most active catalyst and provide processes that run at lower pressures and/or at lower temperatures for a set relative feed and set relative feed rate. The reactor temperature and pressure profiles presented in FIGS. 10 through 12 demonstrate how the reactor pressure can be set autogenously, or in other words is “generated from within” the reaction and reactor process.

In the practice of this disclosure, the crude reaction mixture can be formed by contemporaneous co-feeding the VA and the CD comonomers with hydrogen to a reaction medium comprising the LOXSH catalyst. The relative feed of the total of the VA and CD comonomers to hydrogen can be in the range of about 5 mole to about 50 mole (VA+CD)/mole H₂. The relative feed rates of the combined VA and CD monomer (e.g. styrene and butadiene) to hydrogen can be in the range of about 8 to about 42 mole (VA+CD)/mole H₂. The relative feed can be in the range of about 14 to about 37 mole (VA+CD)/mole H₂. At the range of about 15 to about 30 mole (VA+CD)/mole H₂, the Mₙ of the solvent and oligomer stripped product distribution approaches the theoretical Mₙ=(mole VA+mole CD)/moles H₂)*[x_{VA} FW_{VA}+x_{CD} FW_{CD}](as demonstrated in FIG. 8), wherein x_{VA} FW_{VA} is the multiplicative product of the mole fraction (x_{VA}) and the formula weight (FW_{VA}) of the vinylaromatic monomer and x_{CD} FW_{CD} is the multiplicative product of the mole fraction (X_{CD}) and the formula weight (FW_{CD}) of the conjugated diene monomer. In the processes of this disclosure the contemporaneous co-feed of the VA and CD monomers with H₂ can be conducted over a period of about 20 minutes, about 40 minutes, or about 60 minutes or more. The processes of the disclosure can be conducted up to about 480 minutes in batch or can be longer for a continuous operation. For batch or semi-batch mode of operation the total co-feed times can be in the range of about 60 minutes to about 240 minutes.

In the disclosure, relative feed rate of (VA+CD)/mole H₂/unit time can vary over the range of 0.0333 mole (VA+CD)/mole H₂/min for lowest molecular weight compositions to 0.6667 mole (VA+CD)/mole H₂/min for highest molecular weight compositions. Accordingly relative feed rate of (VA+CD)/H₂/unit time can vary over the range of A) from about [8 mole (styrene+BD)/mole H₂]/240 min=0.0333 mole (styrene+BD)/mole H₂/min to about [8 mole (styrene+BD)/mole H₂]/60 min=0.1333 mole (styrene+BD)/mole H₂/min. for the lowest molecular weights; to about B) [40 mole (styrene+BD)/mole H₂]/240 min=0.1667 mole (styrene+BD)/mole H₂/min to about [40 mole (styrene+BD)/mole H₂]/60 min=0.6667 mole (styrene+BD)/mole H₂/min. for the highest molecular weights. The monomer to hydrogen co-feed time can be in the range of from about 90 minutes to 180 minutes. The relative feed rate of (VA+CD)/H₂/unit time can vary over the range of 0.0833 mole (VA+CD)/mole H₂/min for lowest molecular weight compositions: to 0.3333 mole (VA+CD)/mole H₂/min for the highest molecular weight compositions. Accordingly the relative feed rate of (VA+CD)/mole H₂/unit time can vary over the range of A) from about [15 mole (styrene+BD)/mole H₂]/180 min=0.0833 mole (styrene+BD)/mole H₂/min to about [15 mole (styrene+BD)/mole H₂]/90 min=0.1667 mole (styrene+BD)/mole H₂/min. for the lowest molecular weights; to about B) [30 mole (styrene+BD)/mole H₂]/180 min=0.1667 mole (styrene+BD)/mole H₂/min to about [30 mole (styrene+BD)/mole H₂]/90 min=0.3333 mole (styrene+BD)/mole H₂/min. for the highest molecular weights of the range. The process can be conducted at temperatures in the range of 30° C. and 130° C. with sufficient agitation to assure efficient mass transfer of hydrogen to the condensed phase. Relative feed rates of mole (VA+CD) monomer to mole of contained saline hydride can be from about 70 to about 1500 mole (VA+CD) per mole SH in the LOXSH catalyst composition; wherein the saline hydride, SH, can be one or more of LiH, and/or NaH, and/or KH, and/or MgH₂ and/or CsH and/or RbH. The total weight of comonomer to the total weight of butyllithium used in forming the LOXSH can be in the range of about 20 Kg of total monomer per 1.0 Kg butyllithium to greater than about 400 Kg total monomer per 1.0 Kg of butyllithium charged. This is especially true when the LOXSH catalyst is a LOXNaH catalyst with a Li:Na ratio of 5:1 formed with both an AA and an EA σ−μ polar modifier.

The LOXSH catalyst utilized in the processes of this disclosure includes a σ−μ polar modifier which can be one or more of: N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol with optional addition of one or more of 2-methoxyethanol; 1-methoxy-2-propanol; 1-methoxy-2-butanol; trans-2-methoxycyclohexanol; tetrahydrofurfuryl alcohol; 2-tetrahydropyranyl methanol, and diethylene glycol monomethyl ether.

The LOXSH catalyst utilized can also include a σ−μ polar modifier that can be composed of between about 50 mole % to less than 100 mole % of an tertiary amino-alcohol or tertiary amino-ether-alcohol σ−μ polar modifier and from about 50 mole % to greater than 0 mole % of an ether-alcohol σ−μ polar modifier. The tertiary amino-alcohol σ−μ polar modifier can be selected from one or more of: N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 2-pyrolidinocyclohexanol; 1-phenyl-2-(1-pyrrolidinyl)-1-ethanol; 4-methyl-1-piperazineethanol; 1-(4-methyl-1-piperazinyl)-2-propanol; 1-(4-methyl-1-piperazinyl)-2-butanol; trans-2-(4-methyl-1-piperazinyl)-cyclohexanol; 2-(4-methylpiperazino)-1-phenylethan-1-ol; 1-methyl-2-piperidinemethanol; 1-methyl-2-pyrrolidinemethanol; diethylaminoethanol, N-methyl-diethanolamine, and 3-dimethylamino-1-propanol; 1,3-bis(dimethylamino)-2-propanol; 2-{[2-dimethylamino)ethyl]methylamino}-ethanol. The tertiary amino-ether-alcohol can be 2-morpholinoethanol; 1-(4-morpholinyl)-2-propanol; 1-(4-morpholinyl)-2-butanol; trans-2-morpholin-4-ylcyclohexanol; 2-morpholino-1-phenyl-1-ethanol; 2-[2-(dimethylamino)ethoxy]ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrrolidinyl)ethoxy]ethanol; 2-[2-(4-methyl-1-piperazinyl)ethoxy]ethanol. The ether-alcohol σ−μ polar modifier can be selected from one or more of 2-methoxyethanol; 1-methoxy-2-propanol; 1-methoxy-2-butanol; 2-methoxy-1-phenylethanol; trans-2-methoxycyclohexanol; tetrahydrofurfuryl alcohol; 2-tetrahydropyranyl methanol, and diethylene glycol monomethyl ether.

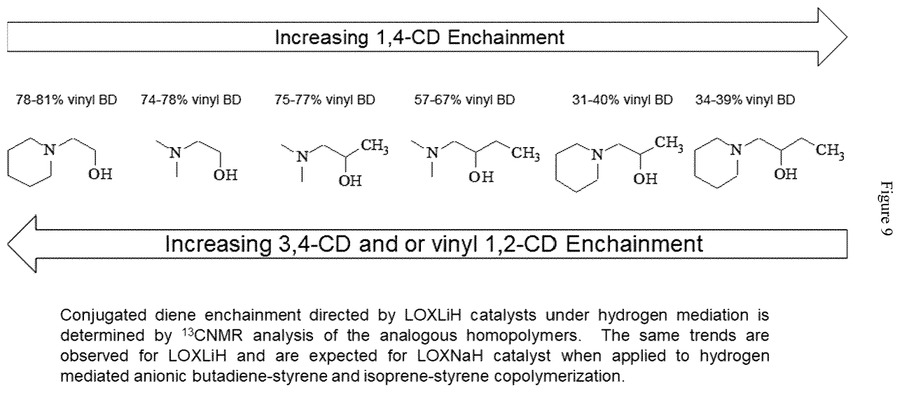

Generally speaking, catalyst activity for a given alcohol functional group of the tertiary aminoalcohol ligand (i.e. 1-aminoethanol, 1-amino-2-propanol, 1-amino-2-butanol, trans-2-amino-cyclohexanol, 2-amino-1-phenyl-1-ethanol) can increase from piperidyl- to dimethyl- to pyrrolyl, while selectivity can generally decrease in that order. Surprisingly, LOXLiH catalyst formed from tertiary amino alcohols processive of secondary alcohols (i.e. 1-amino-2-propanol, 1-amino-2-butanol, trans-2-amino-cyclohexanol), 1-dimethylamino-2-propanol notwithstanding, can be generally more selective towards formation of the 1,4-CD microstructure. In contrast amino alcohols possessive of primary alcohols (2-aminoethanols) can be very selective towards vinyl addition (1,2-BD and 1,2-IP with 3,4-IP) for the CD portion of the copolymer product composition. In general the piperidyl amino functional group can be more selective than the dimethylamino. Accordingly selectivity toward the vinyl microstructure decreases and selectivity for 1,4-CD microstructure can increase in the order: 2-piperidinoethanol; N,N-dimethylethanolamine; 1-(dimethylamino)-2-propanol; 1-(dimethylamino)-2-butanol; 1-piperidino-2-propanol; 1-piperidino-2-butanol (see FIG. 9). Formation of the LOXLiH catalyst with some portion of an ether alcohol generally accelerates the process (the hydrogen mediated polymerization runs at lower temperatures and/or pressures) and yield catalyst compositions that generally favor vinyl addition even when a tertiary amino-alcohol ligand having a 2° alcohol functional group can be employed. Formation of LOXKH catalysts with some portion of an ether alcohol can however impede catalyst activity and require increased temperature. However formation of the LOXNaH catalyst with some portion of ether alcohol will increase its reactivity much like that of the LOXLiH catalysts. Generally speaking catalyst formed with some portion of the ligands as ether alcohols provide compositions that are easier to acid wash forming less of an emulsion than those compositions formed using LOXSH catalyst formed exclusively from aminoalcohol(s) ligands.

The same is true for amino alcohols formed from piperidine as compared to dimethylamine or pyrrolidine. The addition of other polar modifiers (σ type) such as TMEDA and THE can provide some added selectivity towards vinyl addition but generally retard LOXSH catalyst activity (require slightly higher temperatures and pressures); LOXMgH₂ catalysts notwithstanding. The LOXMgH₂ catalyst systems seemed to be greatly affected by the use of TMEDA wherein its addition to the catalyst system strongly promotes the 1,2-PIP and 3,4-PIP microstructure (see Example 12 wherein 36.7 mmoles of TMEDA was added, all other Examples of Table III had none added). Such σ type polar modifiers can also behave as randomizers and thereby help to randomize the distribution and diad sequence of the VA and the CD monomers on any discrete copolymer chain. Potassium based catalyst systems are much more active (run at very low pressures and temperatures) and are generally less selective towards vinyl addition. This disclosure provides several avenues to achieve specific microstructures and molecular weight desired to produce liquid HMPCD-CoPS copolymer compositions with tailor made viscosity and glass transition temperature as well as specified molecular weight distributions.

An embodiment of this disclosure can be the anionic copolymerization reagent compositions formed for (1) an initiation; and/or 2) hydrogen mediation LOXSH catalyst; and/or 3) organic chain transfer LOXSH catalyst that can be selective for 1,4-CD monomer microstructure enchainment in the VA-CD random copolymers. The 1,4 CD microstructure can be achieved with the reagent that can be formed from 1) at least one tertiary amino alcohol σ−μ polar modifiers having a 2° or a 3° alcohol functional group; 2) an organolithium compound; and 3) optionally elemental hydrogen and/or an organo silicon hydride (e.g. phenylsilane). Said LOXSH catalyst composition can be further characterized wherein the polar modifiers can be selected from at least one of the structures:

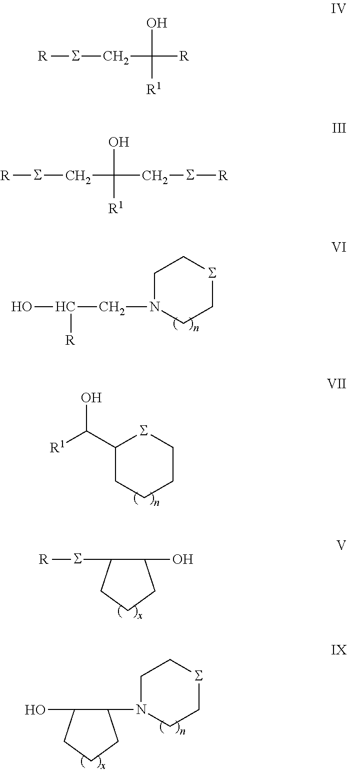

wherein R is independently an organic group which may also be further substituted by other tertiary amines or ethers, R¹ is independently a hydrogen atom or an organic group which may also be further substituted by other tertiary amines or ethers, Σ can include: i) O or NR for III, IV, and V; ii) and for VI, VII, and IX can include O or NR or CH₂; the index value n is independently a whole number equal to or greater than 0, the index value x is independently a whole number equal to or greater than 1.

Preferred LOXSH catalyst composition of the present disclosure include catalyst compositions wherein the σ−μ polar modifier have a secondary alcohol functional group and include one or more of: 1-dimethylamino-2-propanol, 1-piperidino-2-propanol, 1-pyrrolidinylpropan-2-ol, 1-morpholino-2-propanol, 1-(4-Methyl-1-piperazinyl)-2-propanol, 1-dimethylamino-2-butanol 1-piperidino-2-butanol, 1-pyrrolidinylbutan-2-ol, 1-morpholino-2-butanol, 1-(4-methyl-1-piperazinyl)-2-butanol, 2-dimethylaminocyclohexan-1-ol, 2-piperidinocyclohexan-1-ol, 2-pyrolidinocyclohexanol, 2-(4-methyl-1-piperazinyl)-cyclohexanol, 2-morpholinocyclohexan-1-ol, 2-(dimethylamino)-1-phenylethanol; 1-phenyl-2-piperidin-1-ylethanol; 1-phenyl-2-(1-pyrrolidinyl)-1-ethanol; 2-(4-methylpiperazino)-1-phenylethan-1-ol; 2-morpholino-1-phenyl-1-ethanol, 1,3-bis(dimethylamino)-2-propanol with optional addition of one or more of 2-methoxyethanol, 1-methoxypropan-2-ol, 1-methoxybutan-2-ol, 2-methoxycyclohexan-1-ol, 2-methoxy-1-phenylethanol, tetrahydrofurfuryl alcohol, or tetrahydropyran-2-methanol; or diethylene glycol monomethyl ether.

If aralkyl organic chain transfer agents are applied, the organic chain transfer can be designed to compete with hydrogen mediation using a LOXKH catalyst as reagents for aralkyl organic chain transfer agents (e.g. toluene, xylenes, ethylbenzene, propylbenzene, mesitylene and the like). Alternatively, a LOXLiH reagent can be used as an organic chain transfer catalyst when the organic chain transfer agent is substituted with a methyl group (e.g. one or more of toluene, o-, m-, p-xylenes, mesitylene, durene and the like)—under such conditions organic chain transfer can compete to some extent with hydrogen mediation. In certain special cases the VA monomer having an alkyl substitution can additionally act as a chain transfer agent and provide a branching molecular architecture. This is especially true for methyl substituted styrene monomers (i.e. 4-methylstyrene).

Another embodiment of this disclosure can be the anionic copolymerization reagent compositions formed for (1) an initiation; and/or 2) hydrogen mediation LOXSH catalyst; and/or 3) organic chain transfer LOXSH catalyst that is selective for 3,4-CD and/or 1,2-CD-vinyl monomer microstructure enchainment in the VA-CD copolymer. This reagent can be formed from: a) at least one tertiary amino alcohol σ−μ polar modifiers; b) at least one separate ether-alcohol σ−μ polar modifiers; c) an organo lithium compound; and d) optionally elemental hydrogen and/or an organo silicon hydride.

The LOXSH catalyst of this disclosure can be further characterized wherein the σ−μ polar modifiers can be selected from at least two of the of the structures:

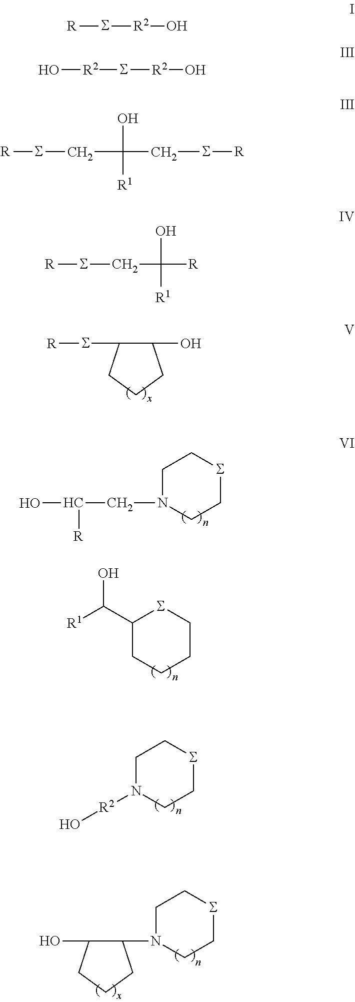

Preferred LOXSH catalyst of this disclosure can be characterized wherein the σ−μ polar modifiers of the reagent comprises between about 50 mole % to less than 100 mole % of a tertiary amino-alcohol σ−μ polar modifier and/or tertiary amino-ether-alcohol σ−μ polar modifier selected from one or more of: I.) N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 2-pyrolidinocyclohexanol; 1-phenyl-2-(1-pyrrolidinyl)-1-ethanol; 4-methyl-1-piperazineethanol; 1-(4-methyl-1-piperazinyl)-2-propanol; 1-(4-methyl-1-piperazinyl)-2-butanol; trans-2-(4-methyl-1-piperazinyl)-cyclohexanol; 2-(4-methylpiperazino)-1-phenylethan-1-ol; 1-methyl-2-piperidinemethanol; 1-methyl-2-pyrrolidinemethanol; diethylaminoethanol, N-methyl-diethanolamine, and 3-dimethylamino-1-propanol; 1,3-bis(dimethylamino)-2-propanol; 2-{[2-dimethylamino)ethyl]methylamino}-ethanol. The tertiary amino-ether-alcohol can be 2-morpholinoethanol; 1-(4-morpholinyl)-2-propanol; 1-(4-morpholinyl)-2-butanol; trans-2-morpholin-4-ylcyclohexanol; 2-morpholino-1-phenyl-1-ethanol; 2-[2-(dimethylamino)ethoxy]ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrrolidinyl)ethoxy]ethanol; 2-[2-(4-methyl-1-piperazinyl)ethoxy]ethanol; and II.) from about 50 mole % to greater than 0 mole % of an ether-alcohol σ−μ polar modifier selected from one or more of 2-methoxyethanol; 1-methoxy-2-propanol; 1-methoxy-2-butanol; trans-2-methoxycyclohexanol; 2-methoxy-1-phenylethanol; tetrahydrofurfuryl alcohol; 2-tetrahydropyranyl methanol, and diethylene glycol monomethyl ether.

Preferred embodiment of the LOXSH catalyst composition of this disclosure can be further characterized wherein the ratio of total amino-alcohol (AA) and or amino-ether-alcohol (AEA) to the total separate ether-alcohol (EE) σ−μ polar modifier ([AA:EAE]:EA) can be in the range of about 9:1 to 1:1 and preferably in the range of about 4:1 to about 2:1.

The hydrogen mediated VA-CD copolymer compositions of the disclosure comprise a polymer of hydrogen, a vinylaromatic comonomer and the conjugated diene comonomer, without incorporation of either an alkyl anion or solvent anion such as toluene that plagues the certain process technologies. Thus, another feature of this disclosure can be hydrogen mediated anionic VA-CD copolymer compositions (comprising copolymers of hydrogen, vinylaromatic monomers and conjugated diene monomers) that can be characterized as having: 1) number average degree of polymerization DPₙ in the range of about 7 to about 50 repeating units; 2) a Brookfield viscosity (45° C.) in the range of about 10 to about 300,000 cP; 3) 1,4-CD microstructure content in the range of 20% to about 80%; and 4) glass transition temperature T_{g} in the range of about −110° C. to about 5° C.

Some hydrogen mediated isoprene-styrene copolymer distribution compositions can be those having a number average DPₙ in the range of about 7 to about 45 and having a number average molecular weight (Mₙ,) in the range of from about 500 to about 3500 Daltons and styrene contents in the range of about 10 wt. % styrene to about 90 wt % and having glass transition temperatures that varies over the range of −100° C. at about 500 Daltons to about 5° at about 3000 Daltons and a Brookfield viscosity (45° C.) in the range of about 100 cP to about 300,000 cP. Some hydrogen mediated isoprene-styrene copolymer distribution compositions can be those characterized as having a number average degree of polymerization (DPₙ) in the range of about 7 to about 27 further characterized as having: 1) 10 wt. % to about 85 wt % styrene content; 2) between 35 wt % and 90 wt % 1,4-PIP content based on the isoprene portion; 3) a glass transition temperatures T_{g} in the range of about −70° C. to about −40° C.; and a Brookfield viscosity (45° C.) in the range of about 280 cP to about 3800 cP.

Some hydrogen mediated butadiene-styrene copolymer distribution compositions can be those having a number average DPₙ in the range of about 8 to about 45 and number average molecular weight (Mₙ,) in the range of from about 500 to about 3300 Daltons and having one of the following: 1) having a styrene contents in the range of about 10 wt. % to about 40 wt. % and having from about 70 wt. % to about 80 wt. % total vinyl content based on the butadiene portion with a Brookfield viscosity (@45° C.) that varies as a function of Mₙ and styrene contents over the range of about 40 cP to about 100,000 cP; or 2) having a styrene contents in the range of about 10 wt. % to about 40 wt. % and having about 40 wt. % to about 65 wt. % total vinyl content based on the butadiene portion with a Brookfield viscosity (@45° C.) that varies as a function of Mₙ and styrene contents over the range of about 10 cP to about 10,000 cP; or 3) having a styrene contents in the range of about 10 wt. % to about 40 wt. % and having wt. % from about 25 wt. % to about 35 wt. % total vinyl content based on the butadiene portion and a Brookfield viscosity (@45° C.) that varies as a function of Mₙ over the range of about 10 cP to about 7,500 cP; wherein the total vinyl content of the butadiene portion is determined by ¹HNMR analyses. These compositions have glass transition temperatures in the range of from less than −110° to about −15° C. over the range of Mₙ=500 Daltons to Mₙ=3300 Daltons wherein the T_{g} increases as a function of molecular weight as well as total vinyl content. Such compositions also have ratios of vinyl-1,2-BD:VCP can be in the range of about 5:1 to about 25:1 (based on ¹HNMR analysis).

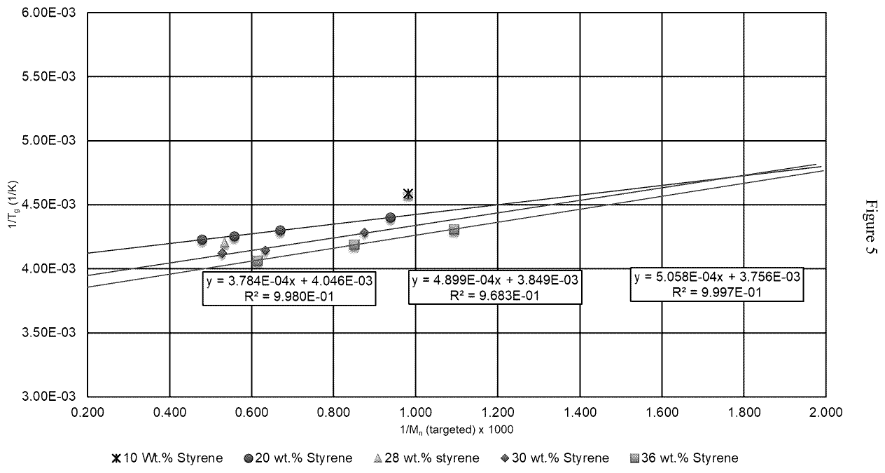

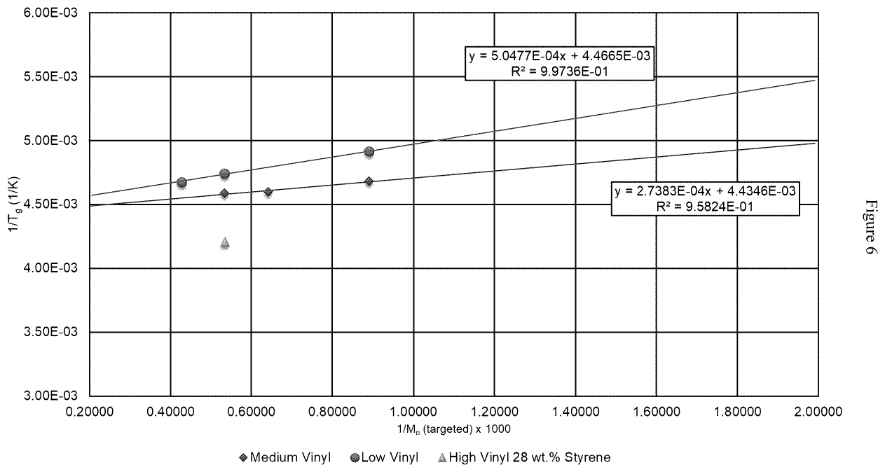

Some of the hydrogen mediated butadiene-styrene copolymer distributions of this disclosure can be of 20 wt. % to 36 wt. % styrene and of high total vinyl content in the range of about 70 wt. % to about 80 wt. % of the butadiene portion (as determined by ¹HNMR analyses) which also exhibit high vinyl-1,2-BD to vinylcyclopentane (VCP) ratios and can be inherently of high reactivity and of low viscosity wherein the: 1) number average molecular weight distribution (Mₙ) can be in the range of about 500 to about 3000 Daltons; 2) Brookfield viscosity (@45° C.) can be in the range of about 165 to about 97,000 cP; 3) glass transition temperature (T_{g}) in the range of less of about −65° C. to about −18° C.; 4) molar ratio of vinyl-1,2-BD:VCP can be in the range of about 12:1 to about 25:1 (based on ¹HNMR analysis); and 5) have iodine numbers of about 280 to about 395. The range of T_{g} data calculated values are presented in Table X the equations are the trendline equations of FIGS. 5 and 6 based on exemplary embodiments of the disclosure. (In this connection see Fox and Loshaek J. Polymer Science 1955, 15, 371.) Iodine numbers which are presented in Table VII are calculated based on the ¹HNMR microstructure analysis according to Equation (2) above. The measured values were conducted by the method found in Kemp, A. and Peters, H., “Unsaturation of butadiene and related polymers as determined by iodine chloride addition” Industrial & Engineering Chemistry Analytical Edition, 1943, 15(7), pp. 453-459. Measured Iodine values are provide for 12 of the 18 Examples of Table VII. It is pointed out that the average iodine value for the sample where in the both calculated and measure values are reported, the average for both is 329 g 12/100 g polymer. The standard deviation of the (calculated—measured) iodine value is 9.6—thus the calculated values which relies on the NMR analyses validate such spectroscopic measurements. It is therefore deemed that these high vinyl hydrogen mediated butadiene-styrene copolymers can be efficiently halogenated (chlorine, bromine as well as iodine) or can be efficiently chemically derivatized by other reagents.

Some of the hydrogen mediated butadiene-styrene copolymer distributions of this disclosure can be of 20 wt. % to 36 wt. % styrene and of high total vinyl content in the range of about 70 wt. % to about 80 wt. % of the butadiene portion (as determined by ¹HNMR analyses) which also exhibit high vinyl-1,2-BD to vinylcyclopentane (VCP) ratios and can be inherently of high reactivity and of low viscosity wherein the: 1) number average molecular weight distribution (Mₙ) can be in the range of about 1000 to about 2000 Daltons; 2) Brookfield viscosity (@45° C.) can be in the range of about 1500 to about 12,500 cP; 3) glass transition temperature T_{g} in the range of about −50° C. to about −25° C.; and 4) molar ratio of vinyl-1,2-BD:VCP can be in the range of about 12:1 to about 25:1 (based on ¹HNMR analysis).

Some of the hydrogen mediated butadiene-styrene copolymer distributions of this disclosure can be of 25 wt. % to 30 wt. % styrene compositions of intermediate total vinyl content in the range of about 40 wt. % to about 65 wt. % of the butadiene portion (as determined by ¹HNMR analyses) wherein the: 1) number average molecular weight distribution (Mₙ) can be in the range of about 1300 to about 2000 Daltons; 2) Brookfield viscosity (@45° C.) can be in the range of about 800 to about 2800 cP; 3) glass transition temperature T_{g} in the range of about −50° C. to about −60° C.; and 4) molar ratio of vinyl-1,2-BD:VCP can be in the range of about 10:1 to about 14:1 (based on ¹HNMR analysis).

Some of the hydrogen mediated butadiene-styrene copolymer distributions of this disclosure can be of 25 wt. % to 30 wt. % styrene content, total vinyl content in the range of about 25 wt. % to about 35 wt. % based on the butadiene portion (as determined by ¹HNMR analyses) wherein the: 1) number average molecular weight distribution (Mₙ) can be in the range of about 1300 to about 2300 Daltons; 2) Brookfield viscosity (@45° C.) can be in the range of about 500 cP to about 3500 cP; 3) glass transition temperature T_{g} in the range of about −55° C. to about −70° C.; and 4) molar ratio of vinyl-1,2-BD:VCP can be in the range of about 7:1 to about 12:1.

Another significant feature of this disclosure can be the seemingly subtle change in the structure or organic framework of the amino-alcohol and/or any ether-alcohol ligand(s) used in forming the LOXSH catalyst composition achieving a dramatic effect on the selectivity as well as the activity of a particular LOXSH catalyst composition. Replacing a simple proton on the organic framework with an alkyl group (e.g. methyl, ethyl, propyl, etc. group(s)) can change the selectivity from greater than 80% vinyl 1,2-BD to as low as 25 wt % total vinyl 1,2-BD in a styrene-butadiene copolymer distribution—and thereby change the reactivity, viscosity and T_{g} of the resulting copolymer composition.

### Analytical Methods:

Molecular weight determinations were made via gel permeation chromatography. Examples 1-3, hydrogen mediated anionically randomly copolymerized polystyrene co-polyisoprene samples were analyzed using OligoPore columns and are based on PS standards internally calibrated (see Application No. WO2017176740A1 for detailed description of method) using a refractive index detector. For Examples 4-12 and Examples 13-30 molecular weight distributions in terms of Mₙ, M_{w}, M_{z}, and PD were obtained by GPC using a Viscotek TDA modular system equipped with a RI detector, autosampler, pump, and temperature-controlled column compartment. The columns used were Agilent ResiPore columns, 300 mm by 7.5 mm, part number 1113-6300. The solvent used was tetrahydrofuran, HPLC grade. The test procedure used entailed dissolving approximately 0.06-0.1 g of sample in 10 mL of THF. An aliquot of this solution is filtered and 200 μl is injected on the columns. Examples 4-12 molecular weight determinations were based on polystyrene standards. Examples 13-30 molecular weight determinations were based on polybutadiene standards having 50% 1,4-BD microstructure and on polystyrene standards. The values reported in Table VII for Mₙ, DPₙ and PDI are based upon the weighted averages of the Mₙ and M_{w} determined from the PBD standards and the PS standards calibration curves according to the equations below:

M_{n wt.}=x_{BD}M_{n PBD}+X_{sty}M_{n PS}

M_{w wt.}=X_{BD}M_{w PBD}+X_{sty}M_{w PS}

Wherein M_{n wt.} is the weighted average number average MWD; x_{BD} is the mole fraction of butadiene in the resin; M_{n PBD} is the number average MWD determined from the BD Standards; x_{sty} is the mole fraction styrene in the resin; and M_{n PS} is the number average MWD determined from the PS Standards. And wherein M_{w wt.} is the weighted average of the weight average MWD; X_{BD} is the weight fraction of butadiene in the resin; M_{w PBD} is the weight average MWD determined from the BD Standards; X_{sty} is the weight fraction styrene in the resin; and M_{w PS} is the weight average MWD determined from the PS Standards. Microstructure analyses for polybutadiene microstructure characterization was based on C13-NMR and ¹HNMR peak assignments in accord with the following reports: Matlengiewcz, M., Kozak, R International Journal of Polymer Anal. Charact. 2015, 20, 574; Fetters, L., Quack, G. Macromolecules, 1978, 11, 369. Total vinyl wt. % content is based on the cyclic structure comprising only vinylcyclopentane and arises from two vinyl motifs (Fetters). The weighted average molecular weight distributions (MWD) as outlined above and the total vinyl content or equivalents are determined in accord with Luxton, A. R., Milner, R., and Young, R. N. Polymer, 1985, 26, 11265. Polybutadiene portion FT-IR microstructure analyses was in accord with: Morero, D; et. al. Chem E Ind. 1959, 41 758.; Shimba, A. et. al. Analytical Sciences 2001, 17, i1503.

### Examples

The following Examples illustrate methods of in situ production of the LOXSH catalyst as well as producing the hydrogen mediated conjugated polymer and co-polymer distributions pursuant to this disclosure. These Examples are not intended to limit the disclosure to only the procedures described therein.

The apparatus used for this work is as follows: 316 stainless steel 2-liter Parr autoclave having thermal couple, bottom drain valve, cooling coils, hot oil jacket, four pitched blade turbine impellers with the first 4.0″, the second 6.0″, the third 8″ and the fourth 10″ from the top of the reactor. The reactor was further equipped with a piston pump, nitrogen purged 250 ml stainless charge vessel, a well calibrated high-pressure metering pump and a 1/16th inch OD subsurface monomer feed line having either a 0.007″ ID terminal section (as noted in the Examples and/or Tables below). The magnetic drive on the agitator is connected to a high-speed air driven motor and generally operated at a near constant 1000-1030 RPMs (adjusting the air flow and pressure as needed as the reaction mixture viscosity changes). Two one-liter gas cylinders outfitted with a digital pressure gauge (readability of 0.01 PSIG) provide a wide spot in the line between the reactor and the hydrogen gas supply. Prior to the start of a run the cylinders are pressured to 435-450 PSIG hydrogen and then isolated from the hydrogen supply. Hydrogen is fed via digital hydrogen mass flow meter with a totalizer. Comonomers of the copolymerization's are either A) premixed as an admixture (e.g. isoprene and styrene) and fed subsurface through a 0.007″ I.D. feed tip; or B) kept in separate tanks but premixed (styrene and butadiene) as through a static mixer in the feed line and delivered to the head space of the reactor. Hydrogen was fed to the headspace. In all cases unless otherwise noted butadiene is fed at a near constant rate of 4.0 g/min as the neat liquid feed—the styrene feed is variable from run to run depending on the desired styrene. butadiene ratio. The butadiene is fed through the bottom drain valve of a Teflon® lined 1000 ml sample cylinder. It is fed to the feedline with positive hydrogen head pressure; about 20-40 PSIG greater than the pressure on the reactor and thus does bring with it a small but inconsequential amount of dissolved hydrogen.

The autoclave is vented to an oil bubbler and/or to a 6-liter oil jacketed creased wash vessel having a bottom drain and outfitted for overhead stirring and distillation. The bottom drain valve and the dip-leg sampling port of the autoclave are both plumbed to the wash vessel for direct transfer of the unquenched reaction mixture. Bulk solvent (e.g., cyclohexane (CH) or methylcyclohexane (MCH) or ethylbenzene (EB) or mixtures thereof recovered from a previous run and thus containing up to 10 wt. % butadiene or isoprene oligomers dimers, trimers mostly) is charged to the reactor via piston pump through the charge vessel. The catalyst components (e.g., polar modifiers and n-butyllithium) are charged separately after dilution with solvent to the reactor through the charging vessels with the flow rate controlled with a fine metering Vernier handle needle valve. The metering valve is coupled to the inlet valve on the reactor's dip-leg by means of a short port connect fitting and further connected to the charge vessel via an 8-inch length of thick walled ⅛″ PTFE tubing. The translucent tubing acts as a sight glass such that the operator can monitor the transfer of the dissolved catalyst components to the reactor and thereby eliminate the introduction of nitrogen by closing a block valve once nitrogen is seen in the line.

The contents of the charge vessel are pressure transferred with a minimum of nitrogen back-pressure to the autoclave having a hydrogen atmosphere. Monomer (or an admixture of monomers) is fed at predetermined constant rates sequentially through 1) a column containing 22 grams of activated 4 A molecular sieves; and then 2) basic alumina column (1 0.5″ O.D columns w/ 11.0 g of 60-325 mesh Al₂O₃); to remove water and to remove the inhibitor. For convenience when forming the isoprene-styrene copolymers of this disclosure, an admixture is formed, placed in the feed tank and then fed with a high-pressure metering pump to the subsurface feed system. When forming the butadiene-styrene copolymers of this disclosure styrene is fed with the metering pump and butadiene is fed from a Teflon® lined 1000 ml charge cylinder described above. The separate styrene and butadiene feeds are fed to the same feedline to a small mixing-tee at a point ahead of the molecular sieve and alumina columns.

The autoclave reactor is heated with oil having a temperature set point at or generally just around ±1C to ±3° C. of the desired reaction temperature (depending on the feed rate and the desired reaction temperature) and the reaction temperatures were tightly maintained at the predetermined set point once the reactor controller lined out (generally no longer than the first 20 minutes of the monomer feed). This is demonstrated in the reactor pressure and temperature feed profile of FIGS. 10-12. The reaction temperature might have brief excursion in temperature generally no more than 5° C. above the desired set-point temperature especially if the initial temperature was lower than optimum and thereby delays the catalyst activation, incubation, and/or initial formation.

Several acronyms for compounds classes: I) amino-alcohols (AA); II) ether-alcohols (EA) and III) amino-ether-alcohols (AEA), either used in these Examples or could be used in processes analogous to these Examples are presented below:
AA-1. DMEA is an acronym for N,N-dimethylethanolamine (Synonym: N,N-Dimethyl-2-hydroxyethylamine, N,N-Dimethylaminoethanol DMAE) as the neutral aminoalcohol. The usage herein in a chemical formula of [DMEA] represents N,N-dimethylethanolamine as an alkoxide having given up one proton to a more basic species.
AA-2. DMAP is an acronym for 1-(dimethylamino)-2-propanol (CAS 108-16-7), syn (I)-1-(N,N-dimethylamino)-2-propanol, dimepranol. N,N-dimethylisopropanolamine.
AA-3. DMAB is an acronym for 1-(dimethylamino)-2-butanol (CAS 3760-96-1) syn. 1-(dimethylamino)butan-2-ol.
AA-4. DMACH is an acronym for trans-2-(dimethylamino)cyclohexanol (CAS 20431-82-7) syn. 2-dimethylaminocyclohexan-1-ol, 2-Dimethylamino-cyclohexanol.
AA-5. PipE and 2-Pip-ethanol are an acronyms for 2-piperidinoethanol (CAS 3040-44-6; synonyms 1-(2-hydroxyethyl piperidine; 1-Piperidineethanol).
AA-6. Pip-2-propanol is an acronym for 1-piperidino-2-propanol (CAS 934-90-7; syn. a-methylpiperidine-1-ethanol).
AA-7. Pip-2-butanol is an acronym for 1-piperidino-2-butanol (CAS 3140-33-8), syn. 1-(Piperidin-1-yl)butan-2-ol.
AA-8. 2-Pip-cyclohexanol is an acronym for trans-2-piperidinocyclohexan-1-ol (CAS 7581-94-4; syn. 2-(piperidin-1-yl)cyclohexan-1-ol; trans-2-piperidinylcyclohexanol).
AA-9. 2-Pyr-ethanol is an acronym for 1-pyrrolidinoethanol (CAS 2955-88-6; N-(2-Hydroxyethyl)pyrrolidine; 1-Pyrrolidineethanol; Epolamine; 1-(2-hydroxyethyl)pyrrolidine).
AA-10. Pyr-2-propanol is an acronym for 1-pyrrolidinylpropan-2-ol (CAS 42122-41-8; 1-(pyrrolidin-1-yl)propan-2-ol; alpha-methylpyrrolidine-1-ethanol).
AA-11. 2-Pyr-2-butanol is an acronym for 1-(1-pyrolidinyl)-2-butanol (CAS 55307-73-8) syn 1-Pyrrolidineethanol, α-ethyl-.
AA-12. 2-Pyr-cyclohexanol is an acronym for 2-pyrolidinocyclohexanol (CAS 14909-81-0; trans-2-pyrrolidinocyclohexanol trans-2-(pyrrolidin-1-yl)cyclohexan-1-ol; (+/−)-trans-2-(pyrrolidin-1-yl)cyclohexanol).
AA-13. 2-Piz-ethanol is an acronym for 4-methyl-1-piperazineethanol (CAS 5464-12-0) syn. (1-(2-Hydroxyethyl)-4-methylpiperazine; 2-(4-methylpiperazin-1-yl)ethanol; 2-(4-Methyl-1-piperazinyl)ethanol).
AA-14. 4-Me-Piz-2-propanol is a synonym for 1-(4-Methyl-1-piperazinyl)-2-propanol (CAS 4223-94-3) syn. 1-(4-methylpiperazin-1-yl)propan-2-ol
AA-15. 4-Me-Piz-2-butanol is a synonym for 1-(4-Methyl-1-piperazinyl)-2-btanol (CAS 56323-03-6) syn 4-(4-methylpiperazin-1-yl)butan-1-ol 1-(4-Hydroxybutyl)-4-methyl-piperazine; 1-Piperazinebutanol, 4-methyl-; 4-(4-methyl-1-piperazinyl)-1-butanol
AA-16. 2-[4-Me-Piz]-cyclohexanol is an acronym for trans-2-(4-methyl-1-piperazinyl)-cyclohexanol (CAS 100696-05-7, syn. trans-2-(4-methylpiperazin-1-yl)cyclohexanol; (+−)-trans-2-(4-methyl-piperazino)-cyclohexanol).
AA-17. MorE is an acronym for 2-morpholinoethanol (CAS 622-40-2); syn. 4-(2-hydroxyethyl)morpholine; 2-(morpholin-4-yl)ethanol; 2-(4-Morpholinyl)ethanol.
AA-18. Mor-2-Propanol is an acronym for 1-(4-Morpholinyl)-2-propanol (CAS 2109-66-2) syn. N-(2-Hydroxypropyl)morpholine; 1-(morpholin-4-yl)propan-2-ol; 2-morpholinoethanol, a-methyl-.
AA-19. Mor-2-butanol is an acronym for 1-(4-Morpholinyl)-2-butanol (CAS 3140-35-0) syn. 1-(morpholin-4-yl)butan-2-ol; 2-morpholinoethanol, a-ethyl-.
AA-20. 2-Mor-cyclohexanol is an acronym for trans-2-morpholin-4-ylcyclohexanol (CAS 14909-79-6) syn. 2-(4-Morpholinyl)cyclohexanol; 2-morpholin-4-ylcyclohexanol
AA-21. N-Me-Pip-2-MeOH is an acronym for N-methylpiperidine-2-methanol (CAS 20845-34-5, 1-Methyl-2-piperidinemethanol; (1-methylpiperidin-2-yl)methanol; 1-methylpiperidine-2-methanol).
AA-22. N-Me-Pry-2-MeOH is an acronym for the chiral and/or the racemic molecule (1-Methyl-2-pyrrolidinyl)methanol (CAS 30727-24-3; 34381-71-0); syn. N-methylprolinol); 1-Methyl-2-pyrrolidinemethanol.
   EA-1. MeOE is an acronym for 2-methoxyethanol as the neutral ether-alcohol. The usage herein in a chemical formula of [MeOE] represents 2-methoxyethanol as an alkoxide having given up one proton to a more basic species.
   EA-2. 1-MeO-2-Propanol is an acronym for 1-methoxy-2-propanol (CAS 107-98-2) syn. 1-Methoxy-2-hydroxypropane; Methoxyisopropanol; 1-methoxypropan-2-ol; Dowanol® PM.
   EA-3. 1-MeO-2-Butanol is an acronym for 1-methoxy-2-butanol (CAS 53778-73-7) syn. 1-Methoxybutan-2-ol.
   EA-4. 2-MeO-cyclohexanol is an acronym for trans-2-Methoxycyclohexanol (CAS 134108-68-2).
   EA-5. THFA is an acronym for tetrahydrofurfuryl alcohol (CAS 97-99-4; syn. (Tetrahydrofuran-2-yl)methanol; Tetrahydro-2-furanmethanol; TFA).

AEA-1. DMAEOE is an acronym for 2-N,N-dimethylaminoethoxyethanol (N(CH₃)₂CH₂CH₂O—CH₂CH₂OH) as the neutral amino ether-alcohol. The usage herein in a chemical formula of [DMAEOE] represents N,N-dimethylaminoethoxyethanol as an alkoxide having given up one proton to a more basic species.

The polar modifiers utilized in forming the catalyst(s) of an Example are designated in the data tables as: I) AA-#; II) EA-#; or III) AEA-#. Accordingly if a Table identifies AA-5 as the AA or polar modifier then that indicates that 2-piperidinoethanol was used in the Example. Likewise if a Table indicates the use of AA-1 and EA-5, then the catalyst of that Example comprises N,N-dimethylethanolamine and tetrahydrofurfuryl alcohol. Additional polar modifiers (σ-type) utilized in forming the catalyst are designated as THE (tetrahydrofuran) and as TMEDA (N,N,N′N′-tetramethylethylenediamie).

### General Procedure Followed in Forming Catalyst

Application No. WO2017176740A1 provides many procedures in which the catalyst useful in the practice of this disclosure can be prepared. The general procedure (with some run-to-run variation as is indicated) followed in this disclosure is described below:

Forming a standard [DMEA]₂Li₃H Catalyst: Anhydrous cyclohexane, 225 ml of 370 ml total, was charged to the reactor at 37.7° C. under a dry hydrogen (22 PSIG H₂) atmosphere. To the stirred solvent (≈750 RPM) was charged through the charge vessel via positive nitrogen pressure, a solution previously formed from 3.908 g (0.0438 mol.) N,N-dimethylethanolamine and 35 g of cyclohexane further combined with 50 ml of the anhydrous solvent from the total above. Next, 33.19 ml (0.0664 mole) 2.0 M n-butyllithium dissolved in 23 g of anhydrous ethylbenzene and 57 g of anhydrous cyclohexane was transferred to the charge vessel and further combined with 50 ml of the anhydrous solvent from the total above. This alkyl lithium solution was then pressure transferred over a period of 9 to 15 minutes to the stirred (≈750 RPM) reaction mixture under hydrogen. After 3 minutes of the transfer the temperature had risen to 38.4° C. and the pressure to 23 PSIG; after 6 minutes of the transfer the temperature had raised to 42.0° C. and the pressure to 25 PSIG. At that point agitation was increased to 1040 RPM; and the transfer was complete in 9 minutes. At the end of the transfer the reactor temperature was 40.8° C. and the pressure had dropped to 22 PSIG. At the end of the organolithium charge the transfer line was flushed with 45 ml of anhydrous solvent from the total above. The reactor was then pressured to 50 to 60 PSIG hydrogen and heated to the desired temperature (68-75° C. typically) and held at that temperature for 100-120 minutes at a pressure of (65-80 PSIG). At the start of the feed the reactor pressure (hydrogen) is set to the desired initial pressure (usually venting down) or is first vented to 0 PSIG and then charged with the specific desired initial charge of hydrogen using the totalizer function of the hydrogen mass flow meter—in both cases prior to initiating the comonomer feed.

Hydrogen Mediated Copolymerization of Isoprene and Styrene with 2-Dimethylaminoethanol derived LOXLiH Catalyst.

For Examples 1-3 (results reported in Table II) it was found that hydrogen mediated anionic co-polymerization of isoprene with styrene can be accomplished using the standard catalyst [DIVEA]₄Li₆H₂ formed from 4 equivalents DMEA, 6 equivalents n-butyllithium and two equivalents of elemental hydrogen.

Example 1 is representative of these three Examples. The procedure for forming the [DMEA]₂Li₃H presented above was followed except that the catalyst was formed from: 4.008 g (0.0455 mole) DMEA; and 34.17 ml (26.530 g, 0.0683 mole) 2 M n-butyllithium. At the end of the catalyst forming step the H₂ pressure was increased from 23 PSIG to 60 PSIG (39.6° C. in the reactor) and the oil jacket temperature was set to 78° C. controlling at 80° C. The catalyst was aged at 71° C. and 80 PSIG for 120 minutes before venting to 10 PSIG. The hydrogen feed rate was set to 250 SCCM and the totalizer was set to 17489.5 standard cm³ (250 standard cm³/minute*59 minutes for a 1-hour monomer feed with a 10-minute flush of the monomer feed line). The styrene-isoprene monomer feed (formed from 416 g, 4.0 mole styrene and 68.1 g, 1.0 mole isoprene) was initiated, feeding 484 g (5.0 mole) of monomer at a rate of 8.68 g/minute. Thus, the molar feed ratio of monomer to hydrogen=8.11. Monomer was fed through a subsurface feed line (0.007″ I.D. tip, 10.30 ft/s) against the initial hydrogen head pressure initially of 12 PSIG for the first 5 minutes with a pressure increase to 13 PSIG over next 15-minute period—at 10 minutes the valve from the hydrogen mass flow meter to the reactor was opened. The liquid volume of the feed line including the void volumes of the molecular sieve and alumina bed is about 23.4 ml. The reactor pressure lined out at 1 PSIG after 50 minutes of feeding.

At the end of the monomer feed, the monomer feedline to the reactor, including the drying columns, were flushed with 50 ml of anhydrous ethylbenzene in 10 ml increments. At the end of the flush, the monomer feed line to the reactor, including the drying columns, were flushed with a second 50 ml of anhydrous ethylbenzene. The monomer feed and flush to the reactor was deemed complete when no further heat of reaction was observed generally signified by the permanent closing of the automated control valve on the cooling coils. The unquenched polymerization reaction mixture was transferred with positive H₂ pressure to the wash vessel previously heated (N₂ atmosphere) and previously charged with 500 ml of deoxygenated water.

The two-phase product mixture was heated to 65° C. in the wash reactor for at least 20 minutes with sufficient mixing to assure good washing of the organic phase by the aqueous and then the phases were separated. Phase cuts were easily made at 65° C. and were rapid requiring little settling time. Water and any rag or emulsion was removed through the bottom drain valve. The reaction mixture is washed twice more: 1) 500 ml dilute formic acid and 2) 500 ml dilute sodium bicarbonate. The neutralized washed product mixture was stripped in the wash reactor of cyclohexane and ethylbenzene by normal distillation while gradually heating the wash reactor's jacket temperature to 155° C. The distillation was deemed complete when the pot temperature reached a temperature above 135° C. The solution was allowed to cool before collecting the entire organic phase. The solution was then further stripped of ethylbenzene with the use of a wiped film evaporator (WFE, 2″ glass Pope Still, operated at 50.0 mmHg vacuum, 142° C., wiper speed 65% of full rate, feeding at 1.0 liters/hr). This WFE operation produced 450 g 93% mass yield of a hydrogen mediated anionic copolymer formed from styrene and isoprene. Said copolymer having Mₙ: 853, M_{w}: 1403, M_{z}: 2071, PD: 1.645, σₙ=685, ₙα₃=2.045 vs. HMAPS oligomer standards (refractive index detector). Further analytical details in terms of microstructure and composition are provided in the Table II below.

Examples 4-12 of Tables III entail the application of 2-Piperidinoethanol based LOXMgH₂ catalyst further modified with triethyl aluminum. Three Examples (Ex. 8, 10 and 11) the catalyst was further modified by the addition of titanium(IV) tert-butoxide. For example 12 only TMEDA (36.7 mmole) was included in the catalyst formulation.

Hydrogen Mediated Copolymerization of Isoprene and Styrene with 2-Piperidinoethanol derived LOXMgH₂ Catalyst.

Forming a LOXMgH₂ Catalysts of this Disclosure: The practitioner of this disclosure can determine the amount, if any, of the titanium (IV) alkoxide activator deemed appropriate for the desired hydrogen mediated VA-CD copolymerization process when using a LOXMgH₂ catalyst. Three Examples (Ex. 8, 10 and 11) of Table III, titanium(IV) tert-butoxide (250-300 mg) was added. The modification of the LOXMgH₂ by the introduction of a titanium (IV) alkoxide reagent appears to lower the autogenous pressure generated as well as shorten the incubation period of the LOXMgH₂ catalyst. This is demonstrated in FIG. 10 wherein the reaction pressure and temperature profiles of Ex. 7 and 8 are compared. For Ex. 7 the hydrogen feed did was not initiated until after the first 40 minutes. For Ex. 8 the hydrogen co-feed was initiated after the first 20 minutes when it was clearly apparent that the catalyst system was active, and the hydrogen mediated anionic copolymerization was proceeding. It is preferred to charge the titanium(IV) species after the dialkylmagnesium reagent is charged. Similarly the practitioner of this disclosure can determine the amount, if any, of an added amount of an aluminum organyl or a boron organyl deemed appropriate. These can be added as separate feeds or combined with the dialkylmagnesium reagent ahead of the charge. Commercial grades of dialkylmagnesium [e.g. butylethylmagnesium (BEM) and di-n-butylmagnesium (DBM)] reagents come as a solution with either low or high aluminum alkyl contents. Aluminum alkyls, [e.g. triethyl aluminum (TEA)] is present in part to cut the viscosity of the otherwise extremely viscous aluminum free solutions of certain dialkylmagnesium reagents. Some alkyls such as sec-butyl-n-butylmagnesium do not form viscous solutions and thus are provided free of aluminum. The practitioner of the process technology of this disclosure can add TEA or other aluminum alkyls as an amendment to the aluminum content of the dialkylmagnesium reagent to be used. Thus a typical low-TEA BEM solution will comprise 4.434 wt. % magnesium (metal basis alone) and 0.1612 wt. % aluminum (metal basis alone) −Mg/Al (mole/mole)=30.54. A typical dibutylmagnesium reagent will comprise 2.984 wt. % magnesium metal and 0.636 wt. % aluminum—Mg/Al (mole/mole)=5.21. Additional TEA can be added (preferably as a solution in hydrocarbon solvent such as toluene) to decrease the Mg/Al (mole/mole) to about 2.9-4.0. Accordingly when forming the LOXMgH₂·TEA catalyst system the ratio of lithium metal to magnesium metal is typically from about 4:1 to about 5:1. Thus the ratio of lithium metal to aluminum metal can be in the range of 115:1 to about 12:1. It has been found that higher and lower ratios than the specified range can impede the hydrogen mediated polymerization processes.

Examples 4-12 of Tables III entail the application of 2-Piperidinoethanol based LOXMgH₂ catalyst further modified with triethylaluminum. Three Examples (Ex. 8, 10 and 11) the catalyst was further modified by the addition of titanium(IV) tert-butoxide.

Example 8 is representative of a the LOXMgH₂·TEA titanium(IV) tert-butoxide catalyzed hydrogen mediated anionic copolymerization of isoprene and styrene. Accordingly anhydrous recycled solvent (comprising 93 wt. % ethylbenzene and 6% cyclohexane and 1% isoprene oligomers) 225 ml of 375 ml total was charged to the reactor at 38° C. (40° C. on the jacket) under a dry hydrogen (23 PSIG H₂) atmosphere. To the stirred solvent (˜890 RPM) was charged through the charge vessel via positive nitrogen pressure (w/o introducing nitrogen to the reactor), a solution previously formed from 7.329 g (0.0567 mole) 2-piperidinoethanol and 30.0 g ethylbenzene. The charge vessel and transfer line to the reactor was flushed with a 25 ml portion of anhydrous solvent from the total amount above. Next, 21.20 g (0.0579 mole) 17.5 wt. % n-butyllithium in cyclohexane further dissolved in 80 g ethylbenzene was transferred through the charge vessel to the reactor followed by 50 ml aliquots of the anhydrous solvent from the total amount above. Then 11.51 g of 2.518 wt. % n-butyl, sec-butylmagnesium solution in heptane was combined with 1.40 g of 25 wt. % TEA in toluene further dissolved in 30.0 g ethylbenzene was charged and transferred through the charge vessel to the reactor followed by a 50 ml aliquot of the anhydrous solvent from the total amount above. During the organomagnesium charge agitation speed was increased to 1100 RPM. Titanium (IV) tert-butoxide (0.300 g, 0.88 mmole) dissolved in 30 g of ethylbenzene was then charged and transferred through the charge vessel to the reactor followed by a 25 ml aliquot of the anhydrous solvent from the total amount above. Thus the catalyst components are combined in a total of about 555 ml of solvent under hydrogen pressure without the introduction of nitrogen. During catalyst formation there is no evidence of hydride formation by the uptake of hydrogen. The reactor is further pressured to about 55 PSIG hydrogen and heated to the desired reaction temperature of 105° C. with a pressure of 76 PSIG. The reactor was vented down to 50 PSIG and an admixture comprising 75 g of styrene and 123 g of isoprene monomer was then fed at a rate of 3.44 g/min over a period of 57.5 minutes. The uptake of hydrogen becomes evident within about 10 minutes as the pressure began to drop and the reactor pressure began to rise (See FIG. 10). After 20 minutes of the feed of the admixture, hydrogen was fed to the reactor at an average rate of 34 SCCM over a period of about 80 minutes. Thus styrene, isoprene and hydrogen were together co-fed to the reactor for a period of about 37 minutes. When the admixture feed was complete the comonomer feed system was flushed to the reactor with 50 ml of anhydrous recycle solvent. Upon the completion of the hydrogen feed, the reaction mixture was allowed to continue to react for 20 minutes before transferring the entire contents to the 6-liter oil jacketed creased wash vessel. The wash vessel was previously charged with 600 ml of solvent recovered from the previous run and 500 ml of water containing 6.7 g of formic acid. The contents of the wash reactor are stirred for at least 20 minutes and heated to about 70° C. Agitation is interrupted and the phases are separated. If needed up to 50 ml of THE is added to the organic phase to help settle any emulsion to the interface with the aqueous phase. The reaction mixture is washed twice more with 500 ml aliquots of water. The washed solution is then dried by azeotropic distillation of a 600 ml portion of the solvent. The resulting dry product solution is then further stripped with a wiped film evaporator (WFE, 2″ glass Pope Still, operated at 50.0 mmHg vacuum, 142° C., wiper speed 65% of full rate, feeding at 1.0 liters/hr). This WFE operation produced 183 g 92.4% mass yield of a hydrogen mediated anionic copolymer formed from styrene and isoprene. Said copolymer having Mₙ: 1224, M_{w}: 2667, M_{z}: 4481, PD: 2.179, σₙ=1329, ₙα₃=2.701 vs. PS standards (refractive index detector). Further analytical details in terms of microstructure, composition physical properties are provided in the Table III below.

Examples 13-30 of Tables IV-VI entail hydrogen mediated anionic copolymerization of butadiene with styrene utilizing a variety of LOXLiH catalysts. In this series of 18 experiments butadiene-styrene copolymers in yields that averaged 96.5% were formed. The reactor system utilized a liquid feed of butadiene from the sample cylinder described above controlling the butadiene fed (maintained as a liquid i.e. no flashing) with a double stem fine metering valve. The double stem fine metering allowed for precise and accurate contemporaneous co-feed of butadiene with styrene to the reactor headspace.

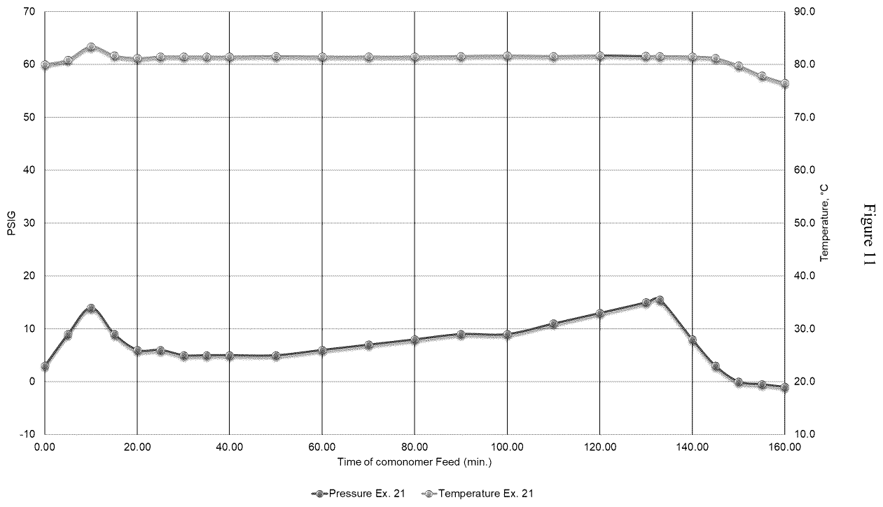

Example 21: Representative of 2-piperidinoethanol based LOXLiH catalyst preparation with subsequent hydrogen mediated anionic chain transfer butadiene-styrene copolymerization employing a constant hydrogen co-feed. The process produced a high vinyl butadiene-styrene copolymer comprising 30 wt. % styrene. The reaction pressure and temperature profile are presented in FIG. 11.

The procedure for forming the [DMEA]₂Li₃H catalyst presented above was followed to form the catalyst composition(s) having the stoichiometry of [AA-5]₂Li₃H (wherein the AA-5 is 2-piperidinoethanol). Thus, the catalyst was formed from: 6.00 g (0.04644 mole) 2-piperidinoethanol; and 17.849 g, (0.0697 mole) 25.2 wt. % n-butyllithium in cyclohexane. At the end of the initial catalyst forming step the H₂ pressure had initially increased from 23 PSIG to 27 PSIG only to drop one psi to 26 PSIG while the temperature increased from 37.5° C. to 40.8° C. (12.5 minutes since starting the butyllithium charge). After completion of the line flush, the pressure was increased to 64 PSIG and was heated 80.0° C. (85° C. on the oil jacket) with a pressure of about 75. Piperidine based polar modifiers of this disclosure tend to form at a slower rate than the analogous dimethylamine-based PMs.

The catalyst was aged at 80° C. and 75 PSIG for 60 more minutes before venting to 0 PSIG. The reactor was then recharged with 326 standard cm³ of Hydrogen to a pressure of 3 PSIG. The contemporaneous butadiene (535 g, 9.891 mole, 4.0 g/min) co-feed with styrene (229.3 g, 2.205 mole, 1.729 g/min) was initiated feeding the combined stream to the headspace of the reactor with 77° C. hot oil on the jacket. It should be noted at the combined feed rate it takes about 5 minutes for the co-monomers to reach the reactor. The pressure increased to 14 PSIG and the temperature to 83.4° C. during that first 15-minute period of the co-feed. In the meantime, after 2.75 minutes of comonomer feed time, the valve from the hydrogen mass flow meter (66.9 SCCM) to the reactor was opened the autogenous pressure lined out at 5 to 9 PSIG over the first 100 minutes. During that time the temperature lined out at 81.6° C. After 132 minutes the contemporaneous cofeed of butadiene, styrene and hydrogen was complete. The totalizer on the hydrogen mass flow meter had been set to 8826 std. cm³ of hydrogen. Accordingly a total of 9152 std. cm³ of hydrogen had been charged. During the last 40 minutes of the cofeed the reactor pressure drifted upwards gradually to 16 PSIG. The reaction mixture was left to stir (1000 to 1030 RPM over the course of the run) for about 25 minutes after the completion of the cofeed. During which time the reaction temperature decreased to 77.8° C. and the pressure dropped to 0 PSIG.

The unquenched polymerization reaction mixture was transferred with positive H₂ pressure to the wash vessel (N₂ atmosphere) previously charged with 500 ml of deoxygenated water and 5.8 g of formic acid. The quenched reaction mixture was stirred for at least 20 minutes before allowing to settle and removal of the aqueous phase. The reaction mixture was then washed twice more with 2×350 ml of water. The reaction mixture was dried by azeotropic distillation of 600 ml of solvent and then further stripped of solvent with the use of a wiped film evaporator (WFE, 2″ glass Pope Still, operated at 12.0 mmHg vacuum, 127° C., wiper speed 70% of full rate, feeding at 1.0 liters/hr). This WFE operation produced 747 g 97.7% yield of a hydrogen mediated anionic butadiene-styrene copolymer composition having Mₙ: 1849, PD: 2.10, (refractive index detector, weighted average values as described above). Further analytical details in terms of microstructure, composition physical properties are provided in Tables VII and VIII below.

Example 29: Representative of 1-piperidino-2-butanol based LOXLiH catalyst preparation with subsequent hydrogen mediated anionic chain transfer butadiene-styrene copolymerization employing a constant hydrogen co-feed. The process produced a high vinyl butadiene-styrene copolymer comprising 30 wt. % styrene. The reaction pressure and temperature profile are presented in FIG. 11 and are compared to Examples 28 and 30 wherein 1-piperidino-2-butanol was also the PM, the same molar ratio of butadiene and styrene was employed (28 wt..% styrene) and the amount of hydrogen initially charged as well as co-fed was varied over the course of the three runs.

The procedure for forming the [DMEA]₂Li₃H catalyst presented above was followed to form the catalyst composition(s) having the stoichiometry of [AA-7]₂Li₃H (wherein the AA-7 is 1-piperidino-2-butanol). Thus, the catalyst was formed from: 8.051 g (0.0512 mole) 2-1-piperidino-2-butanol; and 19.697 g, (0.0768 mole) 25.2 wt. % n-butyllithium in cyclohexane. At the end of the initial catalyst forming step the H₂ pressure had initially increased from 24 PSIG to 27 PSIG while the temperature increased from 37.5° C. to 39.3° C. (19.25 minutes since starting the butyllithium charge). After completion of the line flush, the pressure was increased to 41 PSIG a slight increase in temperature was observed (0.3° C.) and the pressure dropped to 40° C. The jacket was set to 98° C. with the reaction temperature lining out at 89.4° C. with a pressure of about 50 PSIG. As mentioned above the piperidine based polar modifiers—especially those formed to have 2° alcohols—of this disclosure tend to form at a slower rate than the analogous dimethylamine-based PMs. Sometimes it is not clear that the hydride has formed until the monomers are introduced.

The catalyst was aged at 89° C. and 50 PSIG for 90 more minutes before venting to 0 PSIG. The reactor was then recharged with 539.3 standard cm³ of Hydrogen. The reactor was then heated to 97.8° C. with 1100 hot oil on the jacket. At this point the reactor pressure was 9 PSIG. The contemporaneous butadiene (612 g, 11.314 mole, 4.0 g/min) co-feed with styrene (238.0 g, 2.288 mole, 1.568 g/min) was initiated feeding the combined stream to the headspace of the reactor with 97° C. hot oil on the jacket. It should be noted at the combined feed rate it takes about 5 minutes for the co-monomers to reach the reactor. The pressure increased to 37 PSIG and the temperature to 102.2° C. during that first 15-minute period of the co-feed. In the meantime, after 1.86 minutes of comonomer feed time, the valve from the hydrogen mass flow meter (110.0 SCCM) to the reactor was opened the autogenous pressure lined out at 25 to 30 PSIG over the first 140 minutes. During that time the temperature lined out at 100.7° C. After 151.75 minutes the contemporaneous cofeed of butadiene, styrene and hydrogen was complete. The totalizer on the hydrogen mass flow meter had been set to 16615.3 std. cm³ of hydrogen. Accordingly a total of 17154.6 std. cm³ of hydrogen had been charged. During the last 12 minutes of the cofeed the reactor pressure drifted upwards gradually to 33 PSIG. The reaction mixture was left to stir (1000 to 1030 RPM over the course of the run) for about 28 minutes after the completion of the cofeed. During which time the reaction temperature decreased to 95.7° C. and the pressure dropped to 4 PSIG.

The unquenched polymerization reaction mixture was transferred with positive H₂ pressure to the wash vessel (N₂ atmosphere) previously charged with 500 ml of deoxygenated water and 5.9 g of formic acid. The quenched reaction mixture was stirred for at least 20 minutes before allowing to settle and removal of the aqueous phase. The quenched reaction mixture was then washed twice more with 2×350 ml of water. The quenched reaction mixture was dried by azeotropic distillation of 600 ml of solvent and then further stripped of solvent with the use of a wiped film evaporator (WFE, 2″ glass Pope Still, operated at 12.0 mmHg vacuum, 120° C., wiper speed 70% of full rate, feeding at 1.0 liters/hr) to produce 807 g 94.9% yield of a hydrogen mediated anionic butadiene-styrene copolymer composition having Mₙ: 1318, PD: 1.99. Further analytical details in terms of microstructure, composition physical properties are provided in Tables VII and VIII below.

TABLE II

| Example | 1 | 2 | 3 |
|---|---|---|---|
| Catalyst AA | AA-1 | AA-1 | AA-1 |
| Dimethylethanolamine (g) | 4.008 | 4.030 | 4.001 |
| mole lithium/mole PA | 1.520 | 1.607 | 1.524 |
| Initial LiH Equivalent Molarity | 0.046 | 0.054 | 0.046 |
| Styrene (g) | 416.0 | 105.0 | 82.5 |
| wt. % | 85.9% | 27.1% | 18.6% |
| mole % | 80.0% | 20.0% | 13.0% |
| Isoprene (g) | 68.1 | 283.0 | 361.5 |
| wt. % | 14.1% | 72.9% | 81.4% |
| mole % | 20.0% | 80.0% | 87.0% |
| wt. % Isoprene in Crude RM | 0.08% | 1.51% | 0.60% |
| polymer yield, g | 450.0 | 323.6 | 396.6 |
| yield % on monomer | 93.0% | 83.4% | 89.3% |
| Mₙ | 853 | 776 | 1455 |
| M_{w} | 1403 | 1177 | 2671 |
| M_{z} | 2071 | 1724 | 4195 |
| PDₙ | 1.645 | 1.517 | 1.836 |
| σₙ | 685 | 558 | 1330 |
| ₙα₃ | 2.045 | 2.206 | 2.337 |
| wt. % Styrene in the comonomer | 85.9% | 27.1% | 18.6% |
| feed | | | |
| wt. % Polystyrene | 82.48% | 31.61% | 18.74% |
| wt. % Polyisoprene | 16.88% | 67.38% | 80.46% |
| 1,2-IP | 2.22% | 9.43% | 11.05% |
| 3,4-IP | 6.83% | 49.62% | 53.73% |
| 1,4-IP | 90.95% | 40.95% | 35.22% |
| T_{g}, ° C. | | −57.80 | |
| Viscosity, Brookfield 25° C. (cP) | | 791.7 | |

TABLE III

| | Example | | | | | | | | |
|---|---|---|---|---|---|---|---|---|---|
| | 4 | 5 | 6 | 7 | 8 | 9 | 10 | 11 | 12 |
| Piperidine Ethanol, g | 5.852 | 5.852 | 7.324 | 7.324 | 7.324 | 7.325 | 7.329 | 7.329 | 7.331 |
| moles | 0.0453 | 0.0453 | 0.0567 | 0.0567 | 0.0567 | 0.0567 | 0.0567 | 0.0567 | 0.0567 |
| n-butyl, sec-butylmagnesium | 11.50 | 11.50 | 11.51 | 11.51 | 11.51 | 11.58 | 11.51 | 11.58 | 11.61 |
| (2.518 wt. % Magnesium) | | | | | | | | | |
| Magnesium (g) | 0.2896 | 0.2896 | 0.2898 | 0.2898 | 0.2898 | 0.2915 | 0.2898 | 0.2916 | 0.2923 |
| moles | 0.0119 | 0.0119 | 0.0119 | 0.0119 | 0.0119 | 0.0120 | 0.0119 | 0.0120 | 0.0120 |
| TEA in Toluene (ml) | 1.43 | 1.43 | 1.54 | 1.65 | 1.43 | 1.49 | 1.43 | 1.47 | 1.87 |
| moles of Aluminum | 0.0023 | 0.0023 | 0.0024 | 0.0026 | 0.0023 | 0.0024 | 0.0023 | 0.0023 | 0.0030 |
| Mass of 25 wt % Solution | 1.210 | 1.210 | 1.306 | 1.400 | 1.210 | 1.265 | 1.210 | 1.249 | 1.587 |
| Aluminum, g | 0.061 | 0.061 | 0.065 | 0.070 | 0.061 | 0.063 | 0.061 | 0.063 | 0.080 |
| Butyllithium 17.5 wt. % (g) | 19.05 | 19.05 | 21.03 | 21.20 | 21.70 | 21.79 | 21.73 | 21.83 | 21.98 |
| neat mass, g | 3.33 | 3.33 | 3.68 | 3.71 | 3.80 | 3.81 | 3.80 | 3.82 | 3.85 |
| moles | 0.0520 | 0.0520 | 0.0574 | 0.0579 | 0.0593 | 0.0595 | 0.0594 | 0.0596 | 0.0601 |
| mole Lithium/mole | 4.37 | 4.37 | 4.82 | 4.86 | 4.97 | 4.96 | 4.98 | 4.97 | 4.99 |
| Magnesium | | | | | | | | | |
| Mg/Al (mole/mole) | 5.30 | 5.30 | 4.92 | 4.59 | 5.31 | 5.10 | 5.31 | 5.17 | 4.08 |
| Li/Al (mole/mole) | 23.16 | 23.16 | 23.68 | 22.28 | 26.38 | [symbol] | 26.41 | 25.71 | 20.38 |
| total equiv. active | 0.0306 | 0.0306 | 0.0246 | 0.0251 | 0.0264 | 0.0268 | 0.0265 | 0.0269 | 0.0274 |
| Group IA&IIA metal | | | | | | | | | |
| mole lithium/mole (σ-μ) PM | 1.1488 | 1.1488 | 1.0133 | 1.0217 | 1.0457 | 1.0497 | 1.0462 | 1.0510 | 1.0583 |
| (σ-μ) PM/magnesium | 3.80 | 3.80 | 4.75 | 4.75 | 4.75 | 4.73 | 4.76 | 4.73 | 4.72 |
| (mole/mole) | | | | | | | | | |
| Equiv. metal/mole (σ-μ) | 1.67 | 1.67 | 1.43 | 1.44 | 1.47 | 1.47 | 1.47 | 1.47 | 1.48 |
| PM (x-Al) | | | | | | | | | |
| Isoprene, g | 85.1 | 127.7 | 127.7 | 123.0 | 123.0 | 163.3 | 313.4 | 355.0 | 348.8 |
| moles | 1.25 | 1.87 | 1.87 | 1.81 | 1.81 | 2.40 | 4.60 | 5.21 | 5.12 |
| Styrene, g | 114.6 | 57.3 | 57.3 | 75.0 | 75.0 | 21.7 | 41.59 | 0.00 | 41.20 |
| moles | 1.10 | 0.55 | 0.55 | 0.72 | 0.72 | 0.21 | 0.40 | 0.00 | 0.40 |
| Total Monomer, g | 200 | 185 | 185 | 198 | 198 | 185 | 355 | 355 | 390 |
| feed rate g/min | 3.68 | 3.52 | 3.50 | 3.43 | 3.46 | 3.29 | 3.09 | 3.07 | 3.07 |
| Temperature, ° C. | 92-96 | 105-106 | 106-107 | 106-111 | 107 | 110-114 | 106-109 | 108-114 | 92-96 |
| (during H₂ Uptake) | | | | | | | | | |
| Reactor psig | 55-75-19 | 55-69-55 | 55-14 | 51-13 | 50-7 | 53-10 | 45-15 | 47-55-10 | |
| SCCM (average) | 34 | 31 | 38 | 35 | 34 | 30 | 29 | 30 | |
| initial H₂ charge | 2464 | 2464 | 2464 | 2284.8 | 2240 | 2374.4 | 2016 | 2105.6 | NA |
| total Std. cm³ H₂ fed | 2212 | 2143 | 3200 | 2424 | 2744 | 2427 | 4447 | 3925 | |
| total mole H₂ | 0.206 | 0.203 | 0.250 | 0.207 | 0.220 | 0.212 | 0.285 | 0.266 | |
| total Monomer moles | 2.350 | 2.425 | 2.425 | 2.526 | 2.526 | 2.606 | 5.000 | 5.211 | 5.516 |
| Total mole monomer/mole H₂ | 11.4 | 11.9 | 9.7 | 12.2 | 11.5 | 12.3 | 17.6 | 19.6 | NA |
| wt. % Styrene in | 57.4% | 31.0% | 31.0% | 37.9% | 37.9% | 11.7% | 11.7% | 0.0% | 10.6% |
| monomer feed | | | | | | | | | |
| wt. % Polystyrene | 56.75% | 30.07% | 32.64% | 39.32% | 40.48% | 14.79% | 14.39% | 1.49% | 11.39% |
| wt. % Polyisoprene | 33.21% | 67.73% | 64.14% | 57.84% | 56.04% | 82.51% | 83.42% | 96.22% | 85.83% |
| 1,2-PIP | 2.53% | 1.06% | 2.42% | 1.57% | 2.05% | 2.38% | 2.13% | 0.58% | 8.34% |
| 3,4-PIP | 38.18% | 21.23% | 38.01% | 32.62% | 38.13% | 34.17% | 33.88% | 21.50% | 54.15% |
| 1,4-PIP | 59.29% | 77.71% | 59.57% | 65.80% | 59.81% | 63.46% | 63.99% | 77.92% | 37.50% |
| polymer yield, g | 173 | 172 | 145 | 184 | 183 | 163 | 330 | 331 | 372 |
| yield % on monomer | 86.6% | 93.0% | 78.4% | 92.9% | 92.4% | 87.8% | 92.8% | 93.1% | 95.3% |
| T_{g} ° C. | −35.15 | −51.18 | −55.44 | −48.45 | −44.38 | −61.32 | −53.11 | −67.52 | −38.75 |
| Viscosity Brookfield 45° | 2692 | 1408 | 283.3 | 1929 | 1291 | 915.4 | 1189 | 591.7 | 3742 |
| DPₙ | 10.51 | 16.10 | 8.99 | 11.54 | 11.77 | 13.61 | 20.33 | 18.20 | 26.92 |
| Mₙ | 1093 | 1674 | 935 | 1200 | 1224 | 1415 | 2114 | 1893 | 2800 |
| M_{w} | 2534 | 4803 | 1890 | 2553 | 2667 | 4175 | 4804 | 3748 | 5861 |
| M_{z} | 4391 | 7469 | 3252 | 4296 | 4481 | 5310 | 7941 | 5948 | 9185 |
| PDₙ | 2.318 | 2.869 | 2.021 | 2.128 | 2.179 | 2.951 | 2.272 | 1.980 | 2.093 |
| σₙ | 1255 | 2289 | 945 | 1274 | 1329 | 1976 | 2385 | 1874 | 2928 |
| ₙα₃ | 2.879 | 2.424 | 2.874 | 2.701 | 2.688 | 1.549 | 2.591 | 2.352 | 2.263 |

[symbol]

indicates data missing or illegible when filed

TABLE IV

| | Example (All runs at 81° C.) | | | | |
|---|---|---|---|---|---|
| | 13 | 14 | 15 | 16 | 17 |
| Solvent | EB + CH | EB + CH | EB + CH | EB + CH | Recycle |
| CH g | 264.9 | 264.9 | 264.9 | 264.9 | 127.5 |
| Ethylbenzene g | 105.00 | 105.00 | 105.00 | 105.00 | 158.05 |
| Total EB wt. % | 28.4% | 28.4% | 28.4% | 28.4% | 55.3% |
| 1-Piperidine-2-ethanol | 4.000 | 4.000 | 6.000 | 6.000 | 6.000 |
| (AA-5) | | | | | |
| moles | 0.030960 | 0.030960 | 0.046439 | 0.046439 | 0.046439 |
| n-Butyllithium, 25.2 | 11.900 | 11.900 | 17.849 | 17.849 | 17.849 |
| wt. % (g) | | | | | |
| moles | 0.0464 | 0.0464 | 0.0697 | 0.0697 | 0.0697 |
| Butadiene | 556.0 | 350.0 | 608.0 | 605.0 | 605.0 |
| moles | 10.279 | 6.471 | 11.241 | 11.185 | 11.185 |
| Styrene (g) | 62.0 | 87.6 | 152.0 | 152.0 | 152.0 |
| moles | 0.596 | 0.842 | 1.462 | 1.462 | 1.462 |
| vol, ml | 68.584 | 96.903 | 168.1 | 168.1 | 168.1 |
| ml/min | 0.493 | 1.107 | 1.106 | 1.112 | 1.112 |
| Mole Monomer/ | 702.6 | 472.4 | 547.0 | 544.7 | 544.7 |
| Catalyst | | | | | |
| Time of Butadiene Feed | 139.00 | 87.50 | 152.00 | 151.25 | 151.25 |
| (min.) | | | | | |
| Ave. Butadiene feed rate | 4.00 | 4.00 | 4.00 | 4.00 | 4.00 |
| (g/min) | | | | | |
| Total Rxn Time (min.) | 170 | 120 | 175 | 170 | 170 |
| Initial Hydrogen Charge | 400 | 300 | 513 | 435 | 301 |
| (std. cm³) | | | | | |
| Time of Hydrogen co- | 135.0 | 85.7 | 149.8 | 149.0 | 149.0 |
| feed | | | | | |
| Reactor Pressure (PSIG) | 22-32 | 18-21 | 10-22 | 9-12 | 6-17 |
| Hydrogen Feed Rate | 98.8 | 105 | 73.5 | 61.3 | 53.0 |
| (SCCM) | | | | | |
| Std. cm³ Hydrogen | 13738 | 9300 | 11525 | 9569 | 8202 |
| mole Hydrogen | 0.605 | 0.410 | 0.508 | 0.422 | 0.361 |
| mole monomer/ | 18.0 | 17.9 | 25.0 | 30.0 | 35.0 |
| Hydrogen | | | | | |
| wt. % styrene of co- | 10.03% | 20.02% | 20.00% | 20.08% | 20.08% |
| monomer feed | | | | | |
| wt. % styrene in | 10.7% | 19.5% | 20.1% | 20.1% | 19.9% |
| copolymer ¹HNMR | | | | | |

TABLE V

| | Example | | | | | | |
|---|---|---|---|---|---|---|---|
| | 18 | 19 | 20 | 21 | 22 | 23 | 24 |
| Solvent | Recycle | EB | EB | Recycle | Recycle | EB | EB |
| CH g | 127.5 | 264.9 | 264.9 | 127.5 | 127.5 | 264.9 | 264.9 |
| Ethylbenzene g | 158.05 | 105.00 | 105.00 | 158.05 | 158.05 | 105.00 | 105.00 |
| total Solvent vol, ml | 464 | 461 | 461 | 464 | 464 | 461 | 461 |
| Total EB wt. % | 55.3% | 28.4% | 28.4% | 55.3% | 55.3% | 28.4% | 28.4% |
| (σ-μ) PM | AA-2 | AA-5 | AA-5 | AA-5 | AA-5 | AA-5 | AA-5 |
| (σ-μ) PM (g) | 5.250 | 4.000 | 5.000 | 6.000 | 6.000 | 4.000 | 4.000 |
| moles | 0.050890 | 0.030960 | 0.038699 | 0.046439 | 0.046439 | 0.030960 | 0.030960 |
| n-BuLi | 19.560 | 11.900 | 14.874 | 17.849 | 17.849 | 11.900 | 11.900 |
| 25.2 wt. % (g) | | | | | | | |
| moles | 0.0763 | 0.0464 | 0.0580 | 0.0697 | 0.0697 | 0.0464 | 0.0464 |
| Butadiene | 582.0 | 375.0 | 550.0 | 535.0 | 422.0 | 405.0 | 520.0 |
| moles | 10.760 | 6.933 | 10.168 | 9.891 | 7.802 | 7.488 | 9.614 |
| Styrene (g) | 226.3 | 164.5 | 235.6 | 229.3 | 238.0 | 229.7 | 287.4 |
| g/min | 1.56 | 1.76 | 1.71 | 1.71 | 2.26 | 2.27 | 2.21 |
| moles | 2.176 | 1.582 | 2.266 | 2.205 | 2.288 | 2.209 | 2.763 |
| vol, ml | 250.4 | 182.0 | 260.6 | 253.7 | 263.3 | 254.1 | 317.9 |
| ml/min | 1.721 | 1.941 | 1.896 | 1.897 | 2.495 | 2.511 | 2.445 |
| Mole | 508.4 | 550.0 | 642.6 | 520.9 | 434.6 | 626.4 | 799.5 |
| monomer/Catalyst | | | | | | | |
| Temperature, ° C. | 92 | 81 | 81 | 81 | 81 | 81 | 81 |
| Time of BD Feed | 145.50 | 93.73 | 137.49 | 133.73 | 105.50 | 101.20 | 130.00 |
| (min.) | | | | | | | |
| Ave. BD feed rate | 4.00 | 4.00 | 4.00 | 4.00 | 4.00 | 4.00 | 4.00 |
| (g/min) | | | | | | | |
| Total Rxn Time | 160 | 130 | 170 | 155 | 130 | 130 | 170 |
| (min.) | | | | | | | |
| Initial H₂ Charge | 344 | 700 | 490 | 326 | 530.5 | 360 | 415.0 |
| (std. cm³) | | | | | | | |
| Time of H₂ co-feed | 141.2 | 95.24 | 135.0 | 132.0 | 104.5 | 101.2 | 129.8 |
| Reactor Pressure | 8-14 | 14-17 | 10-25 | 5-16 | 9-14 | 12-17 | 10-19 |
| (PSIG) | | | | | | | |
| H₂ Feed Rate | 66.9 | 105 | 80.0 | 66.9 | 151.5 | 117.3 | 83.3 |
| (SCCM) | | | | | | | |
| Std. cm³ H₂ | 9788 | 10700 | 11290 | 9152 | 16361 | 12228 | 11230 |
| mole H₂ | 0.431 | 0.471 | 0.497 | 0.403 | 0.721 | 0.539 | 0.495 |
| mole monomer/H₂ | 30.0 | 18.1 | 25.0 | 30.0 | 14.0 | 18.0 | 25.0 |
| wt. % styrene of | 28.00% | 30.49% | 29.99% | 30.00% | 36.06% | 36.19% | 35.59% |
| co-monomer feed | | | | | | | |
| wt. % styrene in | 27.7% | 30.3% | 30.4% | 29.6% | 35.6% | 36.9% | 35.5% |
| copolymer base | | | | | | | |
| on ¹HNMR | | | | | | | |

TABLE VI

| | Example | | | | | |
|---|---|---|---|---|---|---|
| | 25 | 26 | 27 | 28 | 29 | 30 |
| Solvent | Recycle | Recycle | Recycle | Recycle | Recycle | Recycle |
| CH g | 127.5 | 127.5 | 127.5 | 127.5 | 127.5 | 127.5 |
| Ethylbenzene g | 158.05 | 158.05 | 158.05 | 158.05 | 158.05 | 158.05 |
| total Solvent vol, ml | 465 | 465 | 465 | 465 | 465 | 465 |
| Total EB wt. % | 55.3% | 55.3% | 55.3% | 55.3% | 55.3% | 55.3% |
| (σ-μ) PM | AA-3 | AA-3 | AA-3 | AA-7 | AA-7 | AA-7 |
| (σ-μ) PM (g) | 6.000 | 6.000 | 6.000 | 8.051 | 8.051 | 8.051 |
| (σ-μ) PM (mole) | 0.0512 | 0.0512 | 0.0512 | 0.0512 | 0.0512 | 0.0512 |
| n-Butyllithium, | 19.679 | 19.679 | 19.679 | 19.679 | 19.679 | 19.679 |
| 25.12 wt. % (g) | | | | | | |
| neat mass, g | 4.92 | 4.92 | 4.92 | 4.92 | 4.92 | 4.92 |
| moles | 0.0768 | 0.0768 | 0.0768 | 0.0768 | 0.0768 | 0.0768 |
| Butadiene | 596.0 | 602.0 | 605.0 | 613.0 | 612.0 | 605.0 |
| moles | 11.019 | 11.130 | 11.185 | 11.333 | 11.314 | 11.185 |
| Styrene | 232.0 | 234.3 | 235.4 | 238.5 | 238.0 | 240.0 |
| g/min | 1.56 | 1.56 | 1.56 | 1.56 | 1.56 | 1.59 |
| moles | 2.231 | 2.253 | 2.263 | 2.293 | 2.288 | 2.308 |
| vol, ml | 256.6 | 259.2 | 260.4 | 263.8 | 263.3 | 265.5 |
| ml/min | 1.722 | 1.722 | 1.722 | 1.722 | 1.721 | 1.755 |
| Moles | 517.6 | 522.8 | 525.3 | 532.3 | 531.3 | 527.0 |
| Monomer/Catalyst | | | | | | |
| Temperature, ° C. | 99 | 99 | 99 | 101 | 101 | 101 |
| Time of Butadiene | 149.00 | 150.49 | 151.25 | 153.24 | 153.00 | 151.24 |
| Feed (min.) | | | | | | |
| Average Butadiene | 4.00 | 4.00 | 4.00 | 4.00 | 4.00 | 4.00 |
| feed rate (g/min) | | | | | | |
| Total Rxn Time | 175 | 180 | 180 | 175 | 30 | 180 |
| Initial H₂ Charge | 412.3 | 426.0 | 480.0 | 302.5 | 539.3 | 224.0 |
| (std. cm³) | | | | | | |
| Time of H₂ co-feed | 147.2 | 148.0 | 148.9 | 152.0 | 151.0 | 150.0 |
| Reactor Pressure | 30-27-30 | 31-35 | 35-38 | 19-24 | 25-31 | 16-25 |
| (PSIG) | | | | | | |
| H₂ Feed Rate | 65.3 | 79.2 | 110.6 | 65.8 | 110.0 | 53.0 |
| (SCCM) | | | | | | |
| Std. cm³ H₂ | 10024 | 12152 | 16960 | 10305 | 17155 | 8168 |
| mole H₂ | 0.442 | 0.535 | 0.747 | 0.454 | 0.756 | 0.360 |
| mole monomer/H₂ | 30.003 | 25.000 | 18.000 | 30.016 | 18.000 | 37.499 |
| wt. % styrene of | 28.02% | 28.02% | 28.01% | 28.01% | 28.00% | 28.40% |
| co-monomer feed | | | | | | |
| wt. % styrene in | 27.5% | 27.7% | 27.8% | 27.8% | 26.6% | 28.2% |
| copolymer based | | | | | | |
| on ¹HNMR | | | | | | |

TABLE VII

| | Anal: | | | | | | | | | | |
|---|---|---|---|---|---|---|---|---|---|---|---|
| | Vinyl | Vinyl | 1,2-BD/ | cis/ | Wt. % | I₂N | Visc. cP, | | Weighted Averages | | |
| Ex. | FT-IR | wt. % | VCP | trans | Styrene | Calc/Exp | 45° C. | T_{g}, ° C. | Mₙ | DPₙ | PDI |
| 13 | 67.5% | 74.6% | 13.37 | 0.804 | 10.7% | 397/na. | 610 | −55.23 | 1090 | 19.2 | 1.77 |
| 14 | 64.4% | 74.8% | 13.12 | 0.721 | 19.5% | 358/na. | 1179 | −45.91 | 1204 | 20.1 | 1.88 |
| 15 | 65.9% | 73.7% | 16.73 | 0.691 | 20.1% | 357/354 | 3163 | −40.73 | 1600 | 26.8 | 1.96 |
| 16 | 66.4% | 73.7% | 17.64 | 0.671 | 20.1% | 357/358 | 4710 | −38.01 | 1794 | 30.0 | 1.99 |
| 17 | 66.5% | 73.7% | 18.11 | 0.675 | 19.9% | 358/341 | 6905 | −36.70 | 1982 | 33.2 | 2.04 |
| 18 | 57.2% | 70.3% | 14.68 | 0.751 | 27.7% | 322/321 | 7256 | −35.38 | 1848 | 29.6 | 2.09 |
| 19 | 60.1% | 72.5% | 15.20 | 0.686 | 30.3% | 311/na | 2175 | −39.66 | 1234 | 19.5 | 1.92 |
| 20 | 59.4% | 72.9% | 19.54 | 0.724 | 30.4% | 312/na | 8248 | −31.70 | 1580 | 25.0 | 2.23 |
| 21 | 61.2% | 72.9% | 20.82 | 0.750 | 29.6% | 316/299 | 10732 | −30.43 | 1849 | 29.3 | 2.10 |
| 22 | 56.1% | 72.6% | 13.85 | 0.543 | 35.6% | 287/285 | 1679 | −41.02 | 1091 | 16.7 | 1.96 |
| 23 | 56.0% | 71.9% | 17.13 | 0.630 | 36.9% | 282/na | 3695 | −34.40 | 1268 | 19.4 | 1.99 |
| 24 | 56.3% | 71.9% | 23.48 | 0.633 | 35.5% | 290/na | 12341 | −27.16 | 1586 | 24.3 | 2.27 |
| 25 | 40.5% | 45.3% | 14.07 | 0.691 | 27.5% | 326/334 | 2628 | −55.24 | 1988 | 31.8 | 2.09 |
| 26 | 40.9% | 48.3% | 12.06 | 0.713 | 27.7% | 324/329 | 1750 | −55.68 | 1634 | 26.2 | 1.99 |
| 27 | 41.8% | 49.1% | 10.19 | 0.688 | 27.8% | 322/424 | 842 | −59.56 | 1311 | 21.0 | 1.87 |
| 28 | 30.3% | 35.1% | 10.45 | 0.637 | 27.8% | 324/329 | 2191 | −62.31 | 2005 | 32.1 | 2.07 |
| 29 | 30.9% | 36.4% | 7.19 | 0.833 | 26.6% | 328/333 | 571 | −69.66 | 1318 | 21.1 | 1.99 |
| 30 | 28.9% | 33.0% | 11.52 | 0.676 | 28.2% | 323/340 | 3421 | −59.31 | 2265 | 36.2 | 2.19 |

TABLE VIII

| | Analysis: | | | | | | | | |
|---|---|---|---|---|---|---|---|---|---|
| | Wt. % | MWD Relative to PBD Std. | | | | MWD Relative to PS Std. | | | |
| Example | Sty. | Mₙ | DPₙ | PDI | Asymmetry | Mₙ | DPₙ | PDI | Asymmetry |
| 13 | 10.7% | 1033 | 19.1 | 1.635 | 2.782 | 2073 | 19.9 | 1.956 | 2.724 |
| 14 | 19.5% | 1096 | 20.3 | 1.663 | 2.601 | 2031 | 37.6 | 1.985 | 2.538 |
| 15 | 20.1% | 1459 | 27.0 | 1.731 | 2.369 | 2683 | 25.8 | 2.072 | 2.367 |
| 16 | 20.1% | 1629 | 30.2 | 1.764 | 2.316 | 3057 | 29.4 | 2.077 | 2.294 |
| 17 | 19.9% | 1798 | 33.3 | 1.809 | 2.356 | 3389 | 32.6 | 2.124 | 2.223 |
| 18 | 27.7% | 1620 | 30.0 | 1.783 | 2.299 | 2974 | 28.6 | 2.146 | 2.286 |
| 19 | 30.3% | 1068 | 19.8 | 1.622 | 2.361 | 1961 | 18.9 | 1.952 | 2.330 |
| 20 | 30.4% | 1324 | 24.5 | 1.867 | 3.024 | 2729 | 26.2 | 2.198 | 2.926 |
| 21 | 29.6% | 1600 | 29.6 | 1.779 | 2.896 | 2966 | 28.5 | 2.119 | 2.339 |
| 22 | 35.6% | 947 | 17.5 | 1.607 | 2.220 | 1584 | 15.2 | 2.043 | 2.970 |
| 23 | 36.9% | 1065 | 19.7 | 1.645 | 2.453 | 1958 | 18.8 | 1.978 | 2.428 |
| 24 | 35.5% | 1281 | 23.7 | 1.870 | 3.573 | 2646 | 25.4 | 2.191 | 3.378 |
| 25 | 27.5% | 1732 | 32.1 | 1.788 | 2.286 | 3250 | 31.3 | 2.108 | 2.256 |
| 26 | 27.7% | 1437 | 26.6 | 1.690 | 2.279 | 2608 | 25.1 | 2.049 | 2.259 |
| 27 | 27.8% | 1163 | 21.5 | 1.588 | 2.212 | 2043 | 19.6 | 1.965 | 2.234 |
| 28 | 27.8% | 1715 | 31.8 | 1.791 | 2.184 | 3437 | 33.0 | 2.010 | 2.116 |
| 29 | 26.6% | 1157 | 21.4 | 1.690 | 2.145 | 2112 | 20.3 | 2.061 | 2.212 |
| 30 | 28.2% | 1948 | 36.1 | 1.883 | 2.389 | 3799 | 36.5 | 2.167 | 2.271 |

TABLE IX

| | Analysis: | | | | | | | | | |
|---|---|---|---|---|---|---|---|---|---|---|
| | | total | total | | | | | | | |
| | | Vinyl | Vinyl | 1,2- | Viscosity | Viscosity | | DPₙ | Mₙ | |
| Comp. | Vinyl | wt. % | wt. % | Vinyl/VCP | cP | cP | | (vs. | (vs. | |
| Ex. | FT-IR | ¹HNMR | ¹³C13NMR | ¹HNMR | 25° C. | 45° C. | T_{g}, ° C. | BD) | BD) | PDI |
| A | 73.1% | 74.5% | 80.2% | 9.54 | 1050 | 284 | −63.35 | 19.4 | 1050 | 1.51 |
| B | 72.9% | 74.6% | 80.0% | 9.40 | 1508 | 370 | −61.00 | 21.1 | 1142 | 1.53 |
| C | 67.4% | 70.8% | 77.7% | 12.86 | 2593 | 535 | −63.04 | 25.3 | 1364 | 1.74 |
| D | 67.4% | 70.0% | 76.7% | 12.43 | 4015 | 1000 | −59.22 | 28.4 | 1536 | 1.70 |
| F | 70.9% | 73.3% | 79.5% | 14.02 | 10873 | 4054 | −49.30 | 40.8 | 2204 | 1.88 |
| G | 69.3% | 72.9% | 76.4% | 9.55 | 2386 | 611 | −61.24 | 24.6 | 1329 | 1.60 |
| H | 48.5% | 50.0% | 57.3% | 9.60 | 850 | 309 | −78.66 | 25.7 | 1387 | 1.60 |
| I | 31.4% | 32.4% | 37.5% | 6.43 | 488.2 | 213.2 | −95.61 | 25.5 | 1378 | 1.63 |

TABLE X

| Vinyl | | | | | | | | | | | | |
|---|---|---|---|---|---|---|---|---|---|---|---|---|
| Content | | | | | | | | | | | | |
| approx- | Styrene | | | Visc. | | | Visc. | | | | | Visc. |
| imate | Content | | | cP | | | cP | | | DP_{∞} | | cP |
| wt. % | wt. % | DPₙ | Mₙ | 45° C. | T_{g} | DPₙ | 45° C. | Mₙ | T_{g} | T_{g∞} | Mₙ | 45° C. |
| 35% | 0% | 9.26 | 500 | | −116.97 | 45.00 | | 2430 | −88.86 | −79.85 | | |
| 50% | 0% | 9.26 | 500 | | −100.32 | 45.00 | | 2430 | −76.09 | −68.70 | | |
| 75% | 0% | 9.26 | 500 | 18 | −93.06 | 45.00 | 5,338 | 2430 | −50.97 | −36.70 | 4000 | 13,337 |
| 30% | 28% | 8.06 | 500 | 79 | −90.89 | 45.16 | 5,535 | 2800 | −58.30 | −49.26 | 4000 | 14,244 |
| 40% | 28% | 8.06 | 500 | 139 | −72.79 | 45.16 | 6,436 | 2800 | −52.87 | −47.65 | 4000 | 32,233 |
| 75% | 20% | 8.36 | 500 | 168 | −65.29 | 45.16 | 13,852 | 2700 | −34.62 | −25.99 | 4000 | 38,754 |
| 75% | 30% | 7.94 | 500 | 156 | −66.41 | 45.24 | 46,677 | 2850 | −24.44 | −13.34 | 4000 | 141,689 |
| 75% | 36% | 7.63 | 500 | 301 | −63.75 | 45.42 | 96,849 | 2975 | −18.78 | −6.91 | 4000 | 270,069 |

### Embodiments

Additionally or alternately, the disclosure can include one or more of the following embodiments.

Embodiment 1. A process for copolymerizing conjugated dienes with at least one vinylaromatic comonomer in a hydrocarbon reaction medium, including chemically adding a lithium alkoxide complexed saline hydride LOXSH catalyst to a low boiling conjugated diene and/or to the vinylaromatic comonomer to form a polymerization initiating species, contemporaneously co-feeding the vinylaromatic comonomer with at least two gaseous and/or volatile compounds to the reaction medium, wherein the at least two gaseous and/or volatile compounds comprise hydrogen and the low boiling conjugated diene, and polymerizing at least a portion of the conjugated diene, wherein the LOXSH reagent comprises one or more σ−μ polar modifiers.

Embodiment 2. A process for hydrogen mediated copolymerization of conjugated dienes with at least one vinylaromatic comonomer in a hydrocarbon reaction medium, including chemically adding lithium alkoxide complexed saline hydride (LOXSH) catalyst to a low boiling conjugated diene and/or to the vinylaromatic comonomer to form a polymerization initiating species, and contemporaneously co-feeding the vinylaromatic comonomer with at least two gaseous and/or volatile compounds to the reaction medium, wherein the at least two gaseous and/or volatile compounds comprise hydrogen and the low boiling conjugated diene, wherein the LOXSH catalyst comprises one or more σ−μ polar modifiers.

Embodiment 3. An LOXSH catalyst or reagent composition, wherein the composition is selective for 1,4-CD monomer microstructure enchainment, and the composition comprises 1) at least one tertiary amino alcohol σ−μ polar modifiers having a 2° or a 3° alcohol functional group; 2) an organolithium compound; and 3) optionally elemental hydrogen and/or an organo silicon hydride.

Embodiment 4. An LOXSH catalyst or reagent composition, wherein the composition is selective for 3,4-CD and/or 1,2-CD-vinyl monomer microstructure enchainment in a (VA-CD) copolymer, and the composition comprises: a) at least one tertiary amino alcohol σ−μ or amino-ether-alcohol polar modifiers; b) optionally at least one separate ether-alcohol σ−μ polar modifiers; c) an organo lithium compound; and d) optionally elemental hydrogen and/or an organo silicon hydride.

Embodiment 5. A hydrogen mediated anionic VA-CD copolymer compositions (comprising copolymers of hydrogen, vinylaromatic monomers and conjugated diene monomers) that can be characterized as having: 1) number average degree of polymerization DPₙ in the range of about 7 to about 50 repeating units; 2) a Brookfield viscosity (45° C.) in the range of about 10 to about 300,000 cP; 3) 1,4-CD microstructure content in the range of 20% to about 80%; and 4) glass transition temperature T_{g} in the range of about −110° C. to about 5° C.

Embodiment 6. The processes, catalysts, or compositions of one of the previous embodiments, including contemporaneously co-feeding a vinylaromatic comonomer with the low boiling conjugated diene and the hydrogen in pre-set molar ratios to the polymerization reaction mixture over the course of at least a portion of the entire co-feed wherein the reactor pressure adjusts autogenously to the condensed phase activity of hydrogen and of the conjugated diene at a relative steady state pressure and temperature. The reactor pressure over the course of the process (the autogenously generated reaction pressure) can be the result or product of some combination of the following: a) the relative feed rate of hydrogen to comonomers; b) the feed rate of reactants relative to catalyst concentration; c) the reaction temperature; d) the activity of a particular LOXSH catalyst; and e) the vapor pressure of the reaction medium or solvent(s).

Embodiment 7. The processes, catalysts or compositions of one of the previous embodiments, wherein the relative feed of the total of the VA and CD comonomers to hydrogen can be in the range of about 5 mole to about 50 mole (VA+CD)/mole H₂ the relative feed of the conjugated diene (VA+CD) monomer to hydrogen can be from about 5 mole to about 42 mole (VA+CD)/mole H₂; or wherein the relative feed rate of (VA+CD)/H₂/unit time is from about 0.0333 mole (VA+CD)/mole H₂/min to about 0.6667 mole CD/mole H₂/min; or wherein the relative feed of mole (VA+CD) monomer to mole of saline hydride (SH) is from about 70 mole to about 1500 mole (VA+CD) per mole SH in the LOXSH catalyst; wherein the saline hydride (SH) is one or more of LiH, and/or NaH, and/or KH, and/or MgH₂ and/or CsH; or wherein the conjugated diene comprises one or more of the following: butadiene, isoprene, 2-methyl-1,3-pentadienes (E and Z isomers); piperylene; 2,3-dimethylbutadiene; 2-phenyl-1,3-butadiene; cyclohexadiene; β-myrcene; β-farnesene; and hexatriene; or wherein the conjugated diene comprises one or more of the butadiene and/or isoprene.

Embodiment 8. The processes, catalysts, or compositions of one of the previous embodiments, wherein one or more σ−μ polar modifiers can be selected from one or more of the structures:

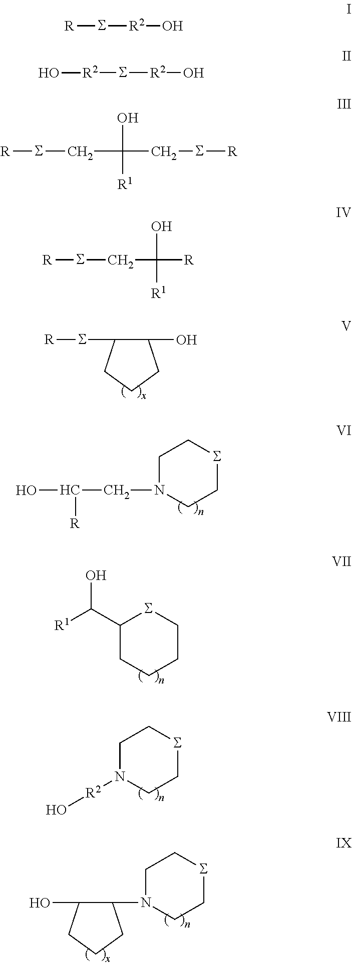

wherein R is independently an alkyl group which may also be further substituted by other tertiary amines or ethers, R¹ is independently a hydrogen atom or an alkyl group which may also be further substituted by other tertiary amines or ethers, R² is —(CH₂)_{y}—, wherein y=2, 3, or 4, Σ can include: i) O or NR for I, II, III, IV, and V; ii) and for VI, VII, VIII and IX can include O or NR or CH₂; n is independently a whole number equal to or greater than 0, and x is independently a whole number equal to or greater than 1.

Embodiment 9. The processes, catalysts or compositions of one of the previous embodiments, wherein the hydrocarbon reaction medium can be a hydrocarbon solvent with a pKₐ greater than that of H₂; or wherein the hydrocarbon reaction medium can include molecular hydrogen and the partial pressure of molecular hydrogen can be maintained at pressures between about 0.01 Bar to about 19.0 Bar; or wherein the autogenous reaction pressure can be between about 0.01 Bar to about 19.0 Bar; or wherein the process can include a temperature and the temperature is maintained between about 20° C. to about 130° C.; or wherein the molar ratio of the total charge of monomer to saline hydride catalyst can be about 10:1 to about 1000:1.

Embodiment 10. The processes, catalysts or compositions of one of the previous embodiments, wherein the σ−μ polar modifier can be one more of N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol. The processes, catalysts or compositions can further include one or more of 2-methoxyethanol, 1-methoxypropan-2-ol, 1-methoxybutan-2-ol, trans-2-methoxycyclohexan-1-ol, 2-methoxy-1-phenylethanol, tetrahydrofurfuryl alcohol, or tetrahydropyran-2-methanol, or diethylene glycol monomethyl ether.

Embodiment 11. The processes, catalysts or compositions of one of the previous embodiments, wherein the LOXSH catalyst includes between about 50 mole % to less than 100 mole % of an tertiary amino-alcohol or a tertiary amino-ether-alcohol σ−μ polar modifier selected from one or more of N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol; and from about 50 mole % to greater than 0 mole % of an ether-alcohol σ−μ polar modifier selected from one or more of 2-methoxyethanol, 1-methoxypropan-2-ol, 1-methoxybutan-2-ol, 2-methoxycyclohexan-1-ol, 2-methoxy-1-phenylethanol; tetrahydrofurfuryl alcohol, tetrahydropyran-2-methanol, diethylene glycol monomethyl ether.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus, the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component, or ingredient as it existed at the time just before it was first contacted, blended, or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

Each and every patent or publication referred to in any portion of this specification is incorporated in toto into this disclosure by reference, as if fully set forth herein.

This disclosure is susceptible to considerable variation in its practice. Therefore the foregoing description is not intended to limit, and should not be construed as limiting, the disclosure to the particular exemplifications presented hereinabove.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based can be readily utilized as a basis for the design of other structures, methods, and systems for carrying out the several purposes of the embodiments and claims presented in this application. It is important, therefore, that the claims be regarded as including such equivalent constructions.

We claim:

1. A process for copolymerizing conjugated dienes with vinylaromatic comonomers in a hydrocarbon reaction medium, comprising
a) chemically adding a lithium alkoxide complexed saline hydride (LOXSH) catalyst to a low boiling conjugated diene to form a polymerization initiating species,
b) contemporaneously co-feeding the vinylaromatic comonomer with at least two gaseous and/or volatile compounds to the reaction medium, wherein the at least two gaseous and/or volatile compounds comprise hydrogen and the low boiling conjugated diene, and
c) polymerizing at least a portion of the conjugated diene,
wherein the LOXSH reagent comprises one or more σ−μ polar modifiers.

2. A process for hydrogen mediated copolymerization of conjugated dienes with vinylaromatic monomers in a hydrocarbon reaction medium, comprising chemically adding lithium alkoxide complexed saline hydride (LOXSH) catalyst to a low boiling conjugated diene and/or to a vinylaromatic comonomer to form a polymerization initiating species, and co-feeding at least two gaseous and/or volatile compounds to the reaction medium, wherein the at least two gaseous and/or volatile compounds comprise hydrogen and the low boiling conjugated diene, wherein the LOXSH catalyst comprises one or more σ−μ polar modifiers.

3. The process of claim 1 or 2 comprising contemporaneously co-feeding the low boiling conjugated diene, the vinylaromatic comonomer and the hydrogen in a pre-set molar ratio to the polymerization reaction mixture over the course of at least a portion of the entire co-feed wherein the reactor pressure adjusts autogenously to the condensed phase activity of hydrogen and the conjugated diene at a relative steady state pressure and temperature.

4. The process of claim 1 or 2 wherein the reactor pressure over the course of the process (the autogenously generated reaction pressure) is the result or product of some combination of the following: a) the relative feed rate of hydrogen to monomer; b) the feed rate of reactants relative to catalyst concentration; c) the reaction temperature; d) the activity of a particular LOXSH catalyst; and e) the vapor pressure of the reaction medium or solvent(s).

5. The process of claim 1 or 2 wherein the relative feed of the total (VA+CD) comonomers to hydrogen is from about 5 mole to about 50 mole CD/mole H₂

6. The process of claim 5, wherein the relative feed rate of (VA+CD)/H₂/unit time is from about 0.0333 mole (VA+CD)/mole H₂/min to about 0.6667 mole (VA+CD)/mole H₂/min.

7. The process of claim 1 or 2 wherein the relative feed of mole total (VA+CD) comonomers to mole of saline hydride (SH) is from about 70 mole to about 1500 mole CD per mole SH in the LOXSH catalyst; wherein the saline hydride (SH) is one or more of LiH, and/or NaH, and/or KH, and/or MgH₂ and/or CsH and/or RbH.

8. The process of claim 1 or 2 wherein the conjugated diene comprises one or more of the following: butadiene, isoprene, 2-methyl-1,3-pentadienes (E and Z isomers); piperylene; 2,3-dimethylbutadiene; 2-phenyl-1,3-butadiene; cyclohexadiene; β-myrcene; β-farnesene; and hexatriene.

9. The process of claim 1 or 2 wherein the conjugated diene comprises one or more of the butadiene and/or isoprene and the vinylaromatic comprises styrene.

10. The process of claim 1 or 2, wherein the vinylaromatic comonomer is one or more of styrene, methyl-styrene(s); C₂-C₁₀ alkylstyrenes; vinyl-naphthalene; alpha-methylstyrene; 4-vinylanisole; 6-methoxy-1-vinylnaphthalene; ortho-, meta-, or para-N,N-dimethylaminostyrene(s); and 6-N,N-dimethylamino-1-vinylnaphthalenes.

11. The process of claim 1 or 2 wherein the one or more σ−μ polar modifiers is selected from one or more of the structures: 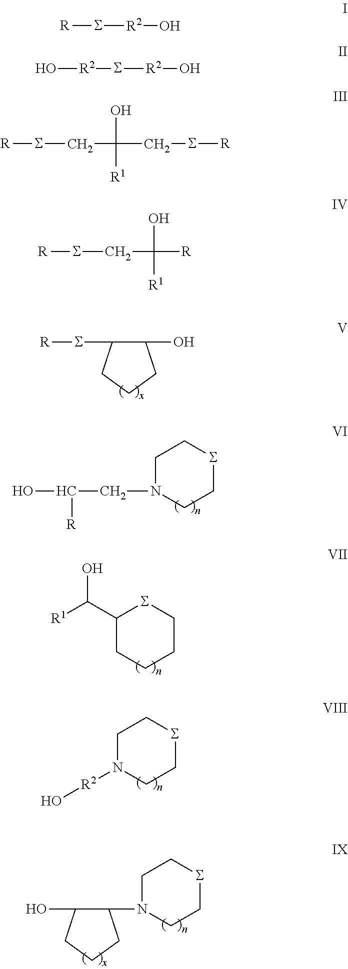
wherein R is independently an alkyl group which may also be further substituted by other tertiary amines or ethers, R¹ is independently a hydrogen atom or an alkyl group which may also be further substituted by other tertiary amines or ethers, R² is —(CH₂)_{y}—, wherein y=2, 3, or 4, Σ can include: i) O or NR for I, II, III, IV, and V; ii) and for VI, VII, VIII and IX can include O or NR or CH₂; n is independently a whole number equal to or greater than 0, and x is independently a whole number equal to or greater than 1.

12. The process of claim 1 or 2 wherein the hydrocarbon reaction medium comprises a hydrocarbon solvent with a pKₐ greater than that of H₂.

13. The process of claim 1 or 2 wherein the hydrocarbon reaction medium includes molecular hydrogen and the partial pressure of molecular hydrogen is maintained at pressures between about 0.01 Bar to about 19.0 Bar.

14. The process of claim 3 or 4, wherein the autogenous reaction pressure is between about 0.01 Bar to about 19.0 Bar.

15. The process of claim 1 or 2 wherein the process includes a temperature and the temperature is maintained between about 20° C. to about 130° C.

16. The process of claim 1 or 2 wherein the molar ratio of the total charge of monomer to saline hydride catalyst is about 10:1 to about 1500:1.

17. The process of claim 1 or 2, wherein the saline hydride catalyst is a one or more of 1) LOXLiH reagent; 2) LOXNaH reagent; 3) LOXMgH₂; and/or 4) LOXKH reagent.

18. The process of claim 1 or 2, wherein the σ−μ polar modifier is one more of N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol.

19. The process of claim 18, further comprising one or more 2-methoxyethanol, 1-methoxypropan-2-ol, 1-methoxybutan-2-ol, trans-2-methoxycyclohexan-1-ol, 2-methoxy-1-phenylethanol, tetrahydrofurfuryl alcohol, or tetrahydropyran-2-methanol, or diethylene glycol monomethyl ether.

20. The process of claim 1 or 2, wherein the LOXSH catalyst comprises between about 50 mole % to less than 100 mole % of an tertiary amino-alcohol or a tertiary amino-ether-alcohol σ−μ polar modifier selected from one or more of N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol; and from about 50 mole % to greater than 0 mole % of an ether-alcohol σ−μ polar modifier selected from one or more of 2-methoxyethanol, 1-methoxypropan-2-ol, 1-methoxybutan-2-ol, trans-2-methoxycyclohexan-1-ol, 2-methoxy-1-phenylethanol, tetrahydrofurfuryl alcohol, or tetrahydropyran-2-methanol, or diethylene glycol monomethyl ether.

21. The process of claim 1 or 2, further comprising either or both of a σ type polar modifier and/or a μ type polar modifier.

22. An LOXSH catalyst or reagent composition, wherein the composition is selective for 1,4-CD monomer microstructure enchainment in a VA-CD copolymer composition, and the LOXSH composition comprises 1) at least one tertiary amino alcohol σ−μ polar modifiers having a 2° or a 3° alcohol functional group; 2) an organolithium compound; and 3) optionally elemental hydrogen and/or an organo silicon hydride.

23. The LOXSH composition of claim 22 wherein the σ−μ polar modifiers are selected from at least one of the structures: 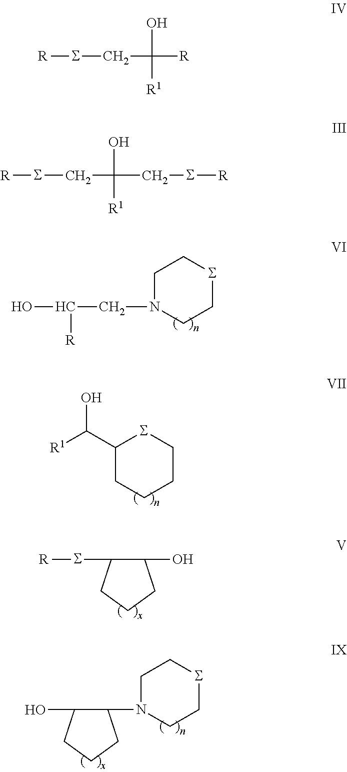
wherein R is independently an alkyl group which may also be further substituted by other tertiary amines or ethers, R¹ is independently a hydrogen atom or an alkyl group which may also be further substituted by other tertiary amines or ethers, Σ can include: i) O or NR for III, IV, and V; ii) and for VI, VII, and IX can include O or NR or CH₂; n is independently a whole number equal to or greater than 0, and x is independently a whole number equal to or greater than 1.

24. The LOXSH composition of claim 22 wherein the σ−μ polar modifier includes one or more of 1-dimethylamino-2-propanol, 1-piperidino-2-propanol, 1-pyrrolidinylpropan-2-ol, 1-morpholino-2-propanol, 1-(4-Methyl-1-piperazinyl)-2-propanol, 1-dimethylamino-2-butanol 1-piperidino-2-butanol, 1-pyrrolidinylbutan-2-ol, 1-morpholino-2-butanol, 1-(4-methyl-1-piperazinyl)-2-butanol, 2-dimethylaminocyclohexan-1-ol, 2-piperidinocyclohexan-1-ol, 2-pyrolidinocyclohexanol, 2-(4-methyl-1-piperazinyl)-cyclohexanol, 2-morpholinocyclohexan-1-ol, 2-(dimethylamino)-1-phenylethanol; 1-phenyl-2-piperidin-1-ylethanol; 1-phenyl-2-(1-pyrrolidinyl)-1-ethanol; 2-(4-methylpiperazino)-1-phenylethan-1-ol; 2-morpholino-1-phenyl-1-ethanol, 1,3-bis(dimethylamino)-2-propanol with optional addition of one or move of 2-methoxyethanol, 1-methoxypropan-2-ol, 1-methoxybutan-2-ol, 2-methoxycyclohexan-1-ol, 2-methoxy-1-phenylethanol, tetrahydrofurfuryl alcohol, tetrahydropyran-2-methanol, diethylene glycol monomethyl ether.

25. An LOXSH catalyst or reagent composition, wherein the composition is selective for 3,4-CD and/or 1,2-CD-vinyl monomer microstructure enchainment, and the composition comprises: a) at least one tertiary amino alcohol σ−μ or amino-ether-alcohol polar modifiers; b) optionally at least one separate ether-alcohol σ−μ polar modifiers; c) an organo lithium compound; and d) optionally elemental hydrogen and/or an organo silicon hydride.

26. The LOXSH composition of claim 25 wherein the σ−μ polar modifiers are selected from at least two of the structures: 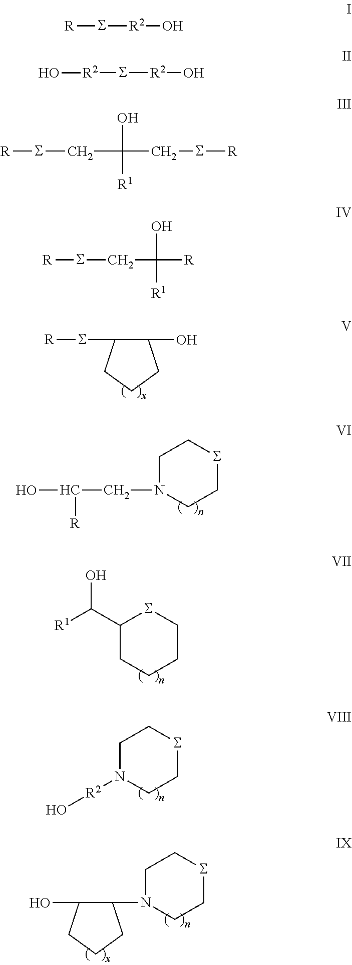
wherein R is independently an alkyl group which may also be further substituted by other tertiary amines or ethers, R¹ is independently a hydrogen atom or an alkyl group which may also be further substituted by other tertiary amines or ethers, R² is —(CH₂)_{y}—, wherein y=2, 3, or 4, Σ can include: i) O or NR for I, II, III, IV, and V; ii) and for VI, VII, VIII and IX can include O or NR or CH₂; n is independently a whole number equal to or greater than 0, and x is independently a whole number equal to or greater than 1.

27. The LOXSH composition of claim 25 wherein the σ−μ polar modifiers of the reagent comprises between about 50 mole % to less than 100 mole % of an tertiary amino-alcohol or an tertiary amino-ether-alcohol σ−μ polar modifier selected from one or more of: I.) N,N-dimethylethanolamine; 1-(dimethylamino)-2-propanol; 1-(dimethylamino)-2-butanol; trans-2-(dimethylamino)cyclohexanol; 2-(dimethylamino)-1-phenylethanol; 2-piperidinoethanol; 1-piperidino-2-propanol; 1-piperidino-2-butanol; trans-2-piperidinocyclohexan-1-ol; 1-phenyl-2-piperidin-1-ylethanol; 1-pyrrolidinoethanol; pyrrolidinylpropan-2-ol; 1-(1-pyrolidinyl)-2-butanol; 1-phenyl-2-(1-pyrrolidinyl)-1-ethanol; 2-pyrolidinocyclohexanol; 4-methyl-1-piperazineethanol; 1-(4-methyl-1-piperazinyl)-2-propanol; 1-(4-methyl-1-piperazinyl)-2-butanol; 2-(4-methylpiperazino)-1-phenylethan-1-ol; trans-2-(4-methyl-1-piperazinyl)-cyclohexanol; 2-morpholinoethanol; 1-(4-morpholinyl)-2-propanol; 1-(4-morpholinyl)-2-butanol; 2-morpholino-1-phenyl-1-ethanol; trans-2-morpholin-4-ylcyclohexanol; 1-methyl-2-piperidinemethanol; 1-methyl-2-pyrrolidinemethanol. diethylaminoethanol, N-methyl-diethanolamine, and 3-dimethylamino-1-propanol, 2-[2-(dimethylamino)ethoxy]ethanol, 1,3-bis(dimethylamino)-2-propanol; 2-{[2-dimethylamino)ethyl]methylamino}ethanol; 2-[2-(dimethylamino)ethoxy]ethanol; 2-(2-(piperidyl)ethoxy)ethanol; 2-[2-(4-morpholinyl)ethoxy]ethanol; 2-[2-(1-pyrolidinyl)ethoxy]ethanol; 2-[2-(4-methyl-1-piperazinyl)ethoxy]ethanol; and II.) from about 50 mole % to greater than 0 mole % of an ether-alcohol σ−μ polar modifier selected from one or more of 2-methoxyethanol, 1-methoxypropan-2-ol, 1-methoxybutan-2-ol, 2-methoxycyclohexan-1-ol, 2-methoxy-1-phenylethanol, tetrahydrofurfuryl alcohol, tetrahydropyran-2-methanol, diethylene glycol monomethyl ether.

28. The LOXSH composition of claim 25 wherein the ratio of total amino-alcohol (AA) and/or amino-ether-alcohol (AEA) to the total separate ether-alcohol (EE) σ−μ polar modifier ([AA+AEA]:EA) is from about 9:1 to about 1:1

29. The LOXSH composition of claim 25 wherein the ratio of total amino-alcohol (AA) and/or amino-ether-alcohol (AEA) to the total separate ether-alcohol (EE) σ−μ polar modifier ([AA+AEA]:EA) is from about 4:1 to about 2:1.

30. A hydrogen mediated anionic VA-CD copolymer composition that is characterized as having: 1) number average degree of polymerization (DPₙ) in the range of about 7 to about 50 repeating units; 2) a Brookfield viscosity (45° C.) in the range of about 10 cP to about 300,000 cP; 3) 1,4-CD microstructure content in the range of 20% to about 80% based on the conjugated diene portion; and 4) glass transition temperature T_{g} in the range of about −110° C. to about 5° C.

31. The composition of claim 30, wherein the composition is a hydrogen mediated isoprene-styrene copolymer distribution compositions can be those having a number average DPₙ in the range of about 7 to about 45 and having a number average molecular weight (Mₙ,) in the range of from about 500 to about 3500 Daltons and styrene contents in the range of about 10 wt. % to about 90 wt. % styrene and having glass transition temperature that varies over the range of −100° C. at about 500 Daltons to about 5° at about 3000 Daltons and a Brookfield viscosity (45° C.) in the range of about 100 cP to about 300,000 cP.

32. The composition of claim 31, characterized as having a number average degree of polymerization (DPₙ) in the range of about 7 to about 27 further characterized as having: 1) 10 wt. % to about 85 wt % styrene content; 2) between 35 wt % and 90 wt % 1,4-PIP content based on the isoprene portion; 3) a glass transition temperatures T_{g} in the range of about −70° C. to about −40° C.; and a Brookfield viscosity (45° C.) in the range of about 280 cP to about 3800 cP.

33. The composition of claim 30, wherein the composition is a hydrogen mediated butadiene-styrene copolymer distribution compositions having a number average DPₙ in the range of about 8 to about 45 and number average molecular weight (Mₙ,) in the range of from about 500 to about 3300 Daltons and having one of the following: 1) having a styrene contents in the range of about 10 wt. % to about 40 wt. % and having from about 70 wt. % to about 80 wt. % total vinyl content based on the butadiene portion with a Brookfield viscosity (@45° C.) that varies as a function of Mₙ and styrene contents over the range of about 40 cP to about 100,000 cP; or 2) having a styrene contents in the range of about 10 wt. % to about 40 wt. % and having about 40 wt. % to about 65 wt. % total vinyl content based on the butadiene portion with a Brookfield viscosity (@45° C.) that varies as a function of Mₙ and styrene contents over the range of about 10 cP to about 10,000 cP; or 3) having a styrene contents in the range of about 10 wt. % to about 40 wt. % and having wt. % from about 25 wt. % to about 35 wt. % total vinyl content based on the butadiene portion and a Brookfield viscosity (@45° C.) that varies as a function of Mₙ over the range of about 10 cP to about 7,500 cP; wherein the total vinyl content of the butadiene portion is determined by ¹HNMR analyses; the compositions have a glass transition temperature in the range of from less than −110° to about −15° C. over the range of Mₙ=500 to Mₙ=3300 Daltons wherein the T_{g} increases as a function of molecular weight as well as total vinyl content and have ratios of vinyl-1,2-BD:VCP in the range of about 5:1 to about 25:1.

34. The composition of claim 30, wherein the composition is a hydrogen mediated butadiene-styrene copolymer distribution compositions further characterized as having 20 wt. % to 36 wt. % styrene and a total vinyl content in the range of about 70 wt. % to about 80 wt. % based on the butadiene portion: 1) number average molecular weight distribution (Mₙ) is in the range of about 500 to about 3000 Daltons; 2) Brookfield viscosity (@45° C.) is in the range of about 165 to about 97,000 cP; 3) glass transition temperature (T_{g}) in the range of less of about −65° C. to about −18° C.; 4) molar ratio of vinyl-1,2-BD:VCP can be in the range of about 12:1 to about 25:1 (vinyl contents based on ¹HNMR analysis); and 5) have iodine numbers of about 280 to about 395.

35. The composition of claim 30, wherein the composition is a hydrogen mediated butadiene-styrene copolymer distributions having 25 wt. % to 30 wt. % styrene content, total vinyl content in the range of about 40 wt. % to about 65 wt. % based on the butadiene portion wherein the: 1) number average molecular weight distribution (Mₙ) can be in the range of about 1300 to about 2000 Daltons; 2) Brookfield viscosity (@45° C.) can be in the range of about 800 cP to about 2800 cP; 3) glass transition temperature T_{g} in the range of about −50° C. to about −60° C.; and 4) molar ratio of vinyl-1,2-BD:VCP can be in the range of about 10:1 to about 14:1 1 (vinyl contents based on ¹HNMR analysis).

36. The composition of claim 30, wherein the composition is a hydrogen mediated butadiene-styrene copolymer distributions having 25 wt. % to 30 wt. % styrene content, total vinyl content in the range of about 25 wt. % to about 35 wt. % based on the butadiene portion wherein the: 1) number average molecular weight distribution (Mₙ) is in the range of about 1300 to about 2300 Daltons; 2) Brookfield viscosity (@45° C.) is in the range of about 500 cP to about 3500 cP; 3) glass transition temperature T_{g} in the range of about −55° C. to about −70° C.; and 4) molar ratio of vinyl-1,2-BD:VCP can be in the range of about 7:1 to about 12:1 1 (vinyl contents based on ¹HNMR analysis).

37. The composition of claim 30, wherein the composition is a hydrogen mediated butadiene-styrene copolymer distribution compositions further characterized as having 20 wt. % to 36 wt. % styrene and a total vinyl content in the range of about 70 wt. % to about 80 wt. % based on the butadiene portion: 1) number average molecular weight distribution (Mₙ) is in the range of about 500 to about 3000 Daltons; 2) Brookfield viscosity (@45° C.) is in the range of about 165 to about 97,000 cP; 3) glass transition temperature (T_{g}) in the range of less of about −65° C. to about −18° C.; 4) molar ratio of vinyl-1,2-BD:VCP can be in the range of about 12:1 to about 25:1 (vinyl contents based on ¹HNMR analysis); and 5) have iodine numbers of about 280 to about 395.

38. A brominated conjugated diene vinyl aromatic copolymer, comprising the bromination product of any of the hydrogen mediated anionic VA-CD copolymer compositions of claim 30.
